(19) United States
(12) Patent Application Publication
(10) Pub. No.: US 2012/0064820 A1
(43) Pub. Date: Mar. 15, 2012

(54) METHOD AND APPARATUS FOR TARGETED COMMUNICATIONS

(76) Inventor: Jeroen Van Bemmel, The Hague (NL)

(21) Appl. No.: 12/878,174

(22) Filed: Sep. 9, 2010

(51) Int. Cl. H04H 20/74; H04H 40/00

(52) U.S. Cl. 455/3.02; 455/3.06

(57) ABSTRACT

A targeted communication capability is provided herein. The targeted communication capability enables targeted delivery of various types of information in various content distribution environments. The information may include content (e.g., text, audio, image, video, multimedia, and the like), recommendations for content and activities, advertisements, and the like. The content distribution environments may include radio systems, the Internet, video-based systems, and the like. The targeted communication capability may include a hybrid radio capability, in which a hybrid radio supports a broadcast audio channel that is used to receive broadcast audio content from broadcast audio content sources and a targeted communication channel configured to enable interaction between the hybrid radio and one or more network devices (e.g., enabling feedback to be provided from the hybrid radio to the network devices and/or enabling information (in addition to the broadcast audio content received via the broadcast audio channel) to be provided to the hybrid radio). The targeted communication capability may support various other types of targeted communication capabilities (e.g., a context-based radio capability, a real-time traffic condition alerting capability, an Internet-based radio capability, a video-based targeted communication capability, and the like, as well as various combinations thereof).

### FIELD OF THE INVENTION

The invention relates generally to communication networks and, more specifically but not exclusively, to providing targeted communications via communication networks.

### BACKGROUND

Many different types of communication media exist today, such as newspapers, radio, television, telephony systems, the Internet and its various services (e.g., social networking sites), and the like. Disadvantageously, however, while many types of communication media are available, the large number of available communication media types results in a fragmenting of the audience. Namely, the audience is scattered across so many different media channels and experiences that it becomes extremely difficult to communicate with the audience in a targeted manner. Furthermore, from the perspective of advertisers, most existing communication media types (especially radio and, more recently, television) are losing their effectiveness as targeted advertising channels. The trend is for advertising to move online, however, this market is currently dominated by a single player and, further, prices often are inflated and based on uncontrollable performance metrics (e.g., trying to determine which of the clicks on a banner or other advertisement are actually real customers or at least potential customers).

### SUMMARY

Various deficiencies in the prior art are addressed by embodiments for providing targeted communications. A targeted communication capability is provided herein. The targeted communication capability enables targeted delivery of various types of information in various content distribution environments. The information may include content (e.g., text, audio, image, video, multimedia, and the like), recommendations for content and activities, advertisements, and the like. The content distribution environments may include radio systems, the Internet, video-based systems, and the like. The targeted communication capability may include a hybrid radio capability, in which a hybrid radio supports a broadcast audio channel that is used to receive broadcast audio content from broadcast audio content sources and a targeted communication channel configured to enable interaction between the hybrid radio and one or more network devices (e.g., enabling feedback to be provided from the hybrid radio to the network devices and/or enabling information (in addition to the broadcast audio content received via the broadcast audio channel) to be provided to the hybrid radio). The targeted communication capability may support various other types of targeted communication capabilities (e.g., a context-based radio capability, a real-time traffic condition alerting capability, an Internet-based radio capability, a video-based targeted communication capability, and the like, as well as various combinations thereof).

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary hybrid radio communications system;

FIG. 2 depicts one embodiment of a method for providing targeted communications in the hybrid radio communications system of FIG. 1;

FIG. 3 depicts one embodiment of a method for providing a context-based radio capability in the hybrid radio communications system of FIG. 1;

FIG. 4 depicts one embodiment of a method for providing a real-time traffic condition alert capability;

FIG. 5 depicts an exemplary audio content website interface page for an Internet-based radio capability;

FIG. 6 depicts an exemplary audio content website content access page for an Internet-based radio capability;

FIG. 7 depicts an exemplary user experience environment illustrating control of the user experience of a user via an Internet-based radio capability;

FIG. 8 depicts one embodiment of a method for using an Internet-based radio capability;

FIG. 9 depicts a high-level block diagram of an exemplary video-based targeted communications system;

FIG. 10 depicts one embodiment of a method for providing a personalized zapping experience using a targeted communication channel;

FIG. 11 depicts one embodiment of a method for providing a personalized zapping experience using local processing; and

FIG. 12 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

A targeted communication capability is depicted and described herein. The targeted communication capability enables targeted delivery of various types of information in various content distribution environments. The information may include content (e.g., text, audio, image, video, multimedia, and the like), recommendations for content and activities, advertisements, and the like. The content distribution environments may include radio systems, the Internet, video-based systems, and the like. The targeted communication capability may include a hybrid radio capability, in which a hybrid radio supports a broadcast audio channel that is used to receive broadcast audio content from broadcast audio content sources and a targeted communication channel configured to enable interaction between the hybrid radio and one or more network devices (e.g., enabling feedback to be provided from the hybrid radio to the network devices and/or enabling information (in addition to the broadcast audio content received via the broadcast audio channel) to be provided to the hybrid radio). The targeted communication capability may support various other types of targeted communication capabilities (e.g., a context-based radio capability, a real-time traffic condition alerting capability, an Internet-based radio capability, a video-based targeted communication capability, and the like, as well as various combinations thereof).

In one embodiment, the targeted communication capability includes one or more audio-based targeted communication capabilities (e.g., a hybrid radio capability, a context-based radio capability, and the like).

In one embodiment, the one or more audio-based targeted communication capabilities include a hybrid radio capability.

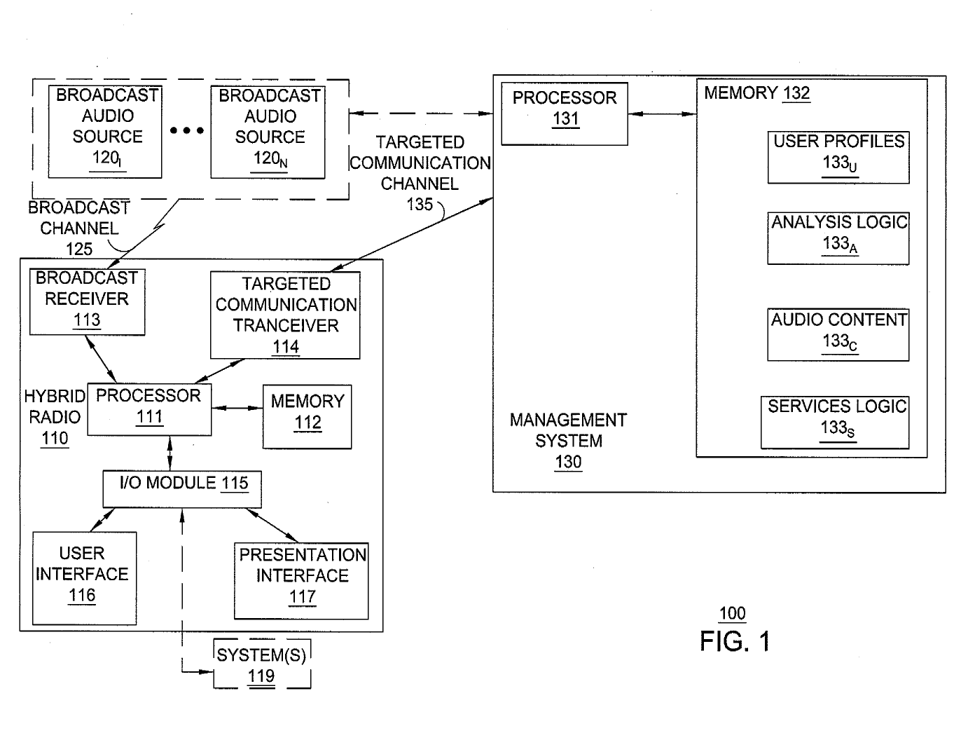

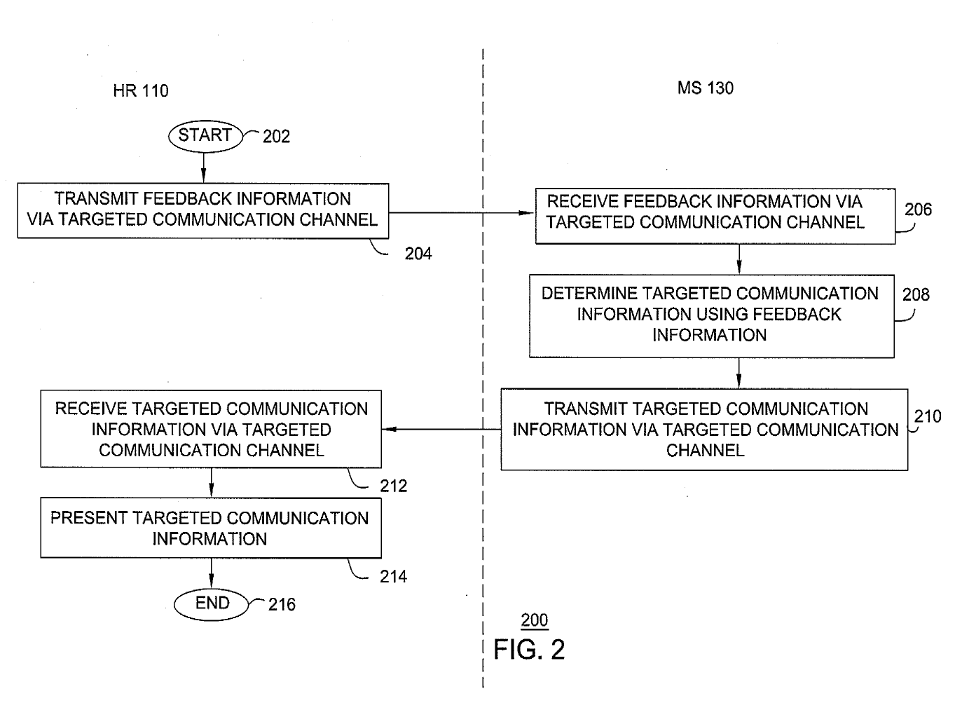

The hybrid radio capability includes a hybrid radio that is configured to support a broadcast channel and an additional communication channel referred to herein as a targeted communication channel. The broadcast channel is used to receive broadcast audio content from broadcast audio content sources. The targeted communication channel is configured to enable interaction between the hybrid radio and the network, and includes an uplink portion from the hybrid radio to the network and/or a downlink portion from the network to the hybrid radio. The targeted communication channel may enable feedback to be provided from the hybrid radio to the network for use in controlling information provided to the hybrid radio. The targeted communication channel may enable information (in addition to broadcast audio content received via the broadcast audio channel) to be provided to the hybrid radio. The information received at the hybrid radio via the targeted communication channel may include one or more of audio content, services, recommendations (e.g., for audio content, services, and the like), and the like, as well as various combinations thereof. Various embodiments of the hybrid radio capability may be better understood by way of reference to FIGS. 1-2 and other figures where the associated teachings are or may used within the context of and/or in conjunction with the hybrid radio capability.

FIG. 1 depicts a high-level block diagram of an exemplary hybrid radio communications system.

The hybrid radio communications system 100 includes a hybrid radio (HR) 110, a plurality of broadcast audio sources (BASs) 120₁-120_{N} (collectively, BASs 120), and a management system (MS) 130.

The HR 110 is a radio configured for supporting a broadcast channel (illustratively, broadcast channel 125 from BASs 120) and a targeted communication channel (illustratively, targeted communication channel 135 supporting interaction with MS 130).

The HR 110 may be any suitable radio device, such as a car radio, a radio in a stereo, a radio in an alarm clock, and the like. Accordingly, at least a portion of the components of which the HR 110 is composed, as well as the arrangement of such component of the HR 110, may vary for different types of radios.

The HR 110 includes a processor 111, a memory 112, a broadcast receiver (BR) 113, a targeted communication transceiver (TCT) 114, an input-output (I/O) module 115, a user interface 116, and a presentation interface 117.

The processor 111 is configured for controlling the operation of HR 110. The processor 111 is coupled to each of memory 112, BR 113, TCT 114, and I/O module 115. The I/O module 115 is coupled to the user interface 116 and the presentation interface 117.

The memory 112 is configured for storing information associated with the operation of HR 110, including programs, data, and the like. For example, memory 112 may store programs for controlling the operation of HR 110, programs for collecting feedback information to be provided from HR 110 to MS 130 via targeted communication channel 135, and the like. For example, memory 112 may store audio content received at HR 110 for playout via HR 110, feedback information to be provided from HR 110 to MS 130 via targeted communication channel 135, targeted communications received at HR 110 via targeted communication channel 135, and the like, as well as various combinations thereof.

The BR 113 is configured for receiving broadcast audio content via broadcast channel 125. It will be appreciated that, although depicted and described as supporting a single broadcast channel 125, BR 113 is adapted for receiving broadcast audio content from any suitable broadcast audio source (illustratively, any of the BASs 120). The BR 113 may be configured for being tuned to receive any suitable broadcast audio content from any suitable broadcast audio source.

The TCT 114 is configured for transmitting feedback information via an uplink and for receiving targeted information via a downlink. The TCT 114 may support any suitable type(s) of bi-directional communications. In one embodiment, TCT 114 supports wireless communications (e.g., at least a portion of the communication path to MS 130 is wireless, e.g., using cellular communications, WiFi communications, and the like, as well as various combinations thereof). This may be used for various types of radios (e.g., car radios, radios within portable audio players, radios integrated within stereos, and the like. In one embodiment, TCT 114 supports wireline communications (e.g., connectivity from HR 110 to an access network via which HR 110 may communicate with MS 130 is wired using any suitable access technologies, e.g., Ethernet, cable access, and the like, as well as various combinations thereof). This may be used for various types of radios (e.g., radios integrated within audio players having network connectivity, Internet-based radios (e.g., where TCT 114 may form part of a network interface portion of a computer on which the Internet-based radio is accessed), and the like). The TCT 114 may support any suitable types of communications protocols. In one embodiment, for example, TCT 114 is configured for supporting IP-based communications, e.g., supporting an IP-based uplink and an IP-based downlink. It will be appreciated that any other suitable communications protocols may be used.

Although primarily depicted and described herein as having bi-directional communication capability, it will be appreciated that in other embodiments the TCT 114 may simply be a transmitter configured for transmitting feedback information (e.g., which may be configured for use in providing targeted information to HR 110 via any other suitable communication channel(s)) or a receiver configured for receiving targeted information (e.g., selected for the associated user based on user profile information available on MS 130 and/or from other network-accessible sources).

Although depicted and described as supporting a single targeted communication channel 135, TCT 114 is adapted for supporting any suitable number of channels supporting any suitable number(s) of sessions (e.g., any suitable number of IP flows), which may be directed to MS 130 and/or any other suitable recipient of feedback information and/or which may originate from MS 130 and/or any other suitable source of targeted communications.

Although depicted and described with respect to a single module supporting targeted communication channel 135 (illustratively, TCT 114), any suitable numbers and/or types of communication modules may be used to support targeted communication channel 135. The communication modules may include one or more receivers, one or more transmitters, one or more transceivers, one or more other types of components suitable for supporting communications via targeted communication channel 135, and the like, as well as various combinations thereof.

The I/O module 115 is configured for supporting communication with user interface 116 and presentation interface 117. The I/O module 115 is configured for receiving user input from user interface 116 and providing the user input to processor 111 for appropriate handling of the user input (e.g., changing of a radio station, adjustment of volume and other audio controls, processing of feedback information for propagation to MS 130, and the like, as well as various combinations thereof). The I/O module 115 is configured for receiving information from processor 111 and providing the information to presentation interface 117 (e.g., for playing audio content via speakers, for displaying information via a display interface (e.g., information about the audio content currently playing, information associated with one or more services that may be provided via HR 110, and the like), and the like, as well as various combinations thereof). Although omitted for purposes of clarity, it will be appreciated that I/O module 115 may interface with any other element(s) of HR 110 for providing various functions depicted and described herein.

The user interface 116 may be any suitable user interface of a radio. For example, the user interface 116 may include one or more user interface controls, such as knobs (e.g., volume, tuning, and the like), buttons (e.g., radio control buttons, station preset buttons, and the like), touch screen controls (e.g., controls for volume, tuning, station presets, and the like), and the like, as well as various combinations thereof. The typical design and operation of a user interface of a radio (as well as the differences between user interfaces of different types of radios) will be understood.

In one embodiment, user interface 116 also may include one or more additional user controls associated with various targeted communication capabilities.

The additional user controls may be any user controls which may be provided in conjunction with various targeted communication capabilities depicted and described herein. For example, the additional user controls may include one or more of LIKE and/or DISLIKE controls adapted for enabling the user to provide real-time feedback regarding audio content playing via HR 110, one or more REPORT CONDITION controls adapted for enabling the user to provide real-time feedback associated with one or more services which may be provided via HR 110 (e.g., to provide user context information associated with a context-based radio capability, to report a traffic condition associated with a real-time traffic condition alerting capability, and the like), and the like, as well as various combinations thereof.

The additional user controls may be implemented using any suitable controls, which may depend on the type of radio. For example, the additional user controls may include one or more buttons, one or more touch screen controls (e.g., which may have image icons associated therewith, which may be displayed at all times, which may be accessible via interaction with various menus and options displayed via a touch screen display, and the like, as well as various combinations thereof), and the like, as well as various combinations thereof).

In one embodiment, in which at least a portion of the user controls are displayed via a touch screen, at least a portion of the displayed user controls may changed based on context. An example may be where a user is driving a car having a hybrid radio supporting various capabilities depicted and described herein. In this example, as context changes (e.g., a traffic jam is encountered, an incoming call is received, and the like), the user control(s) available to the user may change based on context. This embodiment is described in additional detail herein following additional discussion of the hybrid radio capability and various other capabilities which may be used in conjunction with the hybrid radio capability.

The presentation interface 117 may be any suitable presentation interface of, as well as associated with, a radio. The presentation interface 117 includes speakers for playing audio content. The presentation interface 117 also may include one or more displays for displaying information. For example, one or more displays may be used to display information associated with audio content playing via HR 110 (e.g., the station number of the radio station that is selected, the name of the radio station that is selected, the name of the artist, the name of the audio content, and the like, as well as various combinations thereof). For example, one or more displays may be used to display targeted communication information (e.g., recommendations for content and services, information associated with services, and the like, as well as various combinations thereof). The presentation interface 117 also may be used for presenting any other information associated with the targeted communication capabilities depicted and described herein.

The presentation interface 117 may be integrated as part of HR 110 or associated with HR 110. In one embodiment, for example, the presentation interface 117 may be a display that is integrated as part of the radio (e.g., a display on a car radio, a display of a radio of a music player, and the like). In one embodiment, for example, presentation interface 117 may be a display of another system that is used by the radio or a display intended for use by multiple systems including the radio (e.g., a display of a navigation system that is installed within a vehicle and which also is used as the presentation interface for HR 110, a television where HR 110 is integrated or associated with a home entertainment system, and the like).

Although primarily depicted and described herein as being separate, it will be appreciated that in at least some embodiments (e.g., depending on the type of radio and/or the implementation of HR 110), the user interface 116 and presentation interface 117 may be at least partially integrated. For example, in the case of a radio within a vehicle having a touch screen display for use by the radio and a navigation system, various capabilities of user interface 116 and presentation interface 117 may be provided using the touch screen display of the vehicle.

The HR 110 optionally interfaces with one or more systems. As depicted in FIG. 1, in one embodiment the I/O module 115 interfaces with one or more systems 119 which are external to HR 110. The systems 119 may be any suitable systems, which may depend on the type of radio. In one embodiment, for example, in which HR 110 is a radio within a vehicle, the systems 119 may include any vehicle systems which may interface with HR 110 for purposes of providing targeted communication capabilities depicted and described herein. In one embodiment, for example, systems 119 may include a GPS system of the vehicle, (e.g., for purposes of providing vehicle location information to HR 110 so that HR 110 can provide the vehicle location information to MS 130 via targeted communication channel 135, for enabling MS 130 to provide or recommend audio content to the user of HR 110 based on the location of the vehicle, for enabling MS 130 to provide a traffic condition alerting service to the user of HR 110, and the like, as well as various combinations thereof). In one embodiment, for example, systems 119 may include a speed monitoring system of the vehicle, (e.g., for purposes of providing vehicle speed information to HR 110 so that HR 110 can provide the vehicle speed information to MS 130 via targeted communication channel 135, for enabling MS 130 to provide or recommend audio content to the user of HR 110 based on the speed of the vehicle, for enabling MS 130 to provide or recommend content and/or services to the user of HR 110 when the speed of the vehicle falls below a threshold, and the like, as well as various combinations thereof). The HR 110 may interface with any other vehicle systems for providing feedback information to MS 130 via the targeted communication channel 135.

In one embodiment, for example, in which HR 110 is a radio integrated within a home entertainment system, the systems 119 may include any systems of the home entertainment system with which HR 110 may interface for purposes of providing targeted communication capabilities depicted and described herein. In one embodiment, for example, systems 119 may include a television or associated television receiver of the home entertainment system (e.g., for purposes of providing, to HR 110, information indicative of the type of video-based content playing on the television so that HR 110 can provide the video-based content information to MS 130 via targeted communication channel 135, such as for enabling MS 130 to provide or recommend audio content to the user of HR 110 based on the video-based content, for enabling MS 130 to provide or recommend one or more services to the user of HR 110 based on the video-based content, and the like, as well as various combinations thereof). The HR 110 may interface with any other systems of the home entertainment system for providing feedback information to the MS 130 via the targeted communication channel 135.

Although primarily depicted and described herein with respect to specific types and arrangements of elements, it will be appreciated that different types of radios may utilize different types and/or arrangements of elements for providing the hybrid radio capability depicted and described herein.

As described herein, HR 110 is configured for receiving broadcast audio content from BASs 120 and for interacting with MS 130 for providing various targeted communication capabilities depicted and described herein.

The BASs 120 may include any broadcast audio sources, such as AM radio stations, FM radio stations, satellite radio stations, and the like. The HR 110 receives broadcast audio content from BASs 120 via broadcast channel 125). It will be appreciated that, from the perspective of BASs 120, broadcast channel 125 to HR 110 has different properties (i.e., the different BASs 120 support different broadcast channels to which HR 110 may tune in order to receive the broadcast audio content from the different BASs 120).

The MS 130 is a management system configured for providing various targeted communication capabilities.

The MS 130 supports a targeted communication channel 135 with HR 110, thereby enabling interaction between HR 110 and MS 130 for purposes of providing various targeted communication capabilities. The targeted communication channel 135 includes an uplink portion from HR 110 to MS 130 (e.g., enabling feedback to be provided from HR 110 to MS 130) and a downlink portion from MS 130 to HR 110 (e.g., enabling targeted information to be provided from MS 130 to HR 110). As described herein, the targeted information provided to HR 110 may include one or more of audio content, services, recommendations (e.g., for audio content, services, and the like), and the like, as well as various combinations thereof. As described herein, targeted communication channel 135 may be implemented using any suitable type(s) of bi-directional communications, which may utilize wireless and/or wireline communication capabilities. As described herein, targeted communication channel 135 may support any suitable types of communications protocols. In one embodiment, for example, targeted communication channel 135 is an IP-based communication channel, e.g., supporting an IP-based uplink and an IP-based downlink. It will be appreciated that any other suitable communications protocols may be used. Although depicted and described herein as being bi-directional, it will be appreciated that in other embodiments, the targeted communication channel 135 may be unidirectional, e.g. implemented as either an uplink or downlink communication channel.

The MS 130 is configured for receiving feedback information from HR 110 via targeted communication channel 135, processing the feedback information for identifying targeted communication information to be provided to HR 110, and propagating the targeted communication information to HR 110. The MS 130 also may be configured for communicating with various other elements for purposes of providing such functions (e.g., one or more other sources of input information which may be processed for identifying targeted communication information to be provided to HR 110, one or more elements configured for providing targeted communication information to HR 110 in response to instructions from MS 130, and the like, as well as various combinations thereof).

The MS 130 includes a processor 131 and a memory 132. The processor 131 cooperates with memory 132 for providing various targeted communication capabilities depicted and described herein (e.g., executing programs and control logic, accessing data for processing, processing feedback information received from HR 110, storing targeted communication information to be provided to HR 110, and the like, as well as various combinations thereof). The memory 132 stores programs, data, and like information suitable for use in providing various targeted communication capabilities depicted and described herein. In one embodiment, memory 132 stores user profiles 133_{U}, analysis logic 133_{A}, audio content 133_{C}, and services logic 133_{S}. The memory 132 may store any other programs, data, and like information depicted and described herein.

The user profiles 133_{U} include information associated with users. The user profiles may be stored at any granularity (e.g., on a per-HR basis which may include multiple users, on a per-user basis even where multiple users access the same HR, and the like, as well as various combinations thereof). The user profiles 133_{U} may store general user information configured by and/or on behalf of users (e.g., as part of a registration process, based on users updating their profiles, and the like). The user profiles 133_{U} may include feedback information received from the users (e.g., from HR 110 via targeted communication channel 135, from one or more other devices via which the users may provide feedback that is associated with their HRs 110 (e.g., via smartphones, via computers, and the like), and the like, as well as various combinations thereof). The user profiles 133_{U} may include information received and/or retrieved by MS 130 from one or more other network elements (e.g., from other network elements maintaining user profile information). The user profiles 133_{U} may include any other suitable input information which may be analyzed for determining targeted communication information to provide to the users via their HRs. In one embodiment, the user profiles 133_{U} also may include some or all of the targeted communications information determined for the users by MS 130 (e.g., audio content provided to and/or recommended to the users, services provided to and/or recommended to the users, and the like, as well as various combinations thereof). The user profiles 133_{U} may include any other suitable information.

The analysis logic 133_{A} is configured for analyzing information for purposes of determining targeted communications information for users. For example, analysis logic analysis logic 133_{A} may analyze information (e.g., one or more of user profile information from user profiles 133, feedback information received from HR 110 via targeted communication channel 135, audio content 133_{C} and/or services logic 133_{S}, and the like) for purposes of selecting one or more of audio content to be provided to HR 110 via targeted communication channel 135, one or more services to be provided to HR 110 via targeted communication channel 135, one or more recommendations (e.g., for content, services, and the like) to be provided to HR 110 via targeted communication channel 135, and the like, as well as various combinations thereof.

The audio content 133_{C} includes audio content items available to be provided to HR 110 via targeted communication channel. The audio content 133_{C} may include any suitable types of audio content items (e.g., songs, clips from radio shows, audio books, and the like). The MS 130 is configured for searching audio content 133_{C} for selecting audio content to be provided to HR 110, making recommendations of audio content to the user of HR 110, and for performing like functions (e.g., based on user profile information from user profiles 133_{U}, feedback information received from HR 110 via targeted communication channel 135, and the like, as well as various combinations thereof). Although primarily depicted and described herein with respect to embodiments in which the audio content available to be provided to HR 110 is stored on MS 130 as audio content 133_{C}, it will be appreciated that the audio content available to be provided to HR 110 may be stored on any other suitable device(s).

The services logic 133_{S} is configured for providing one or more services to the user of HR 110.

The services of services logic 133_{S} may be provided using any suitable services delivery platform. In one embodiment, for example, one or more services may be provided to the user of HR 110 via HR 110 and associated targeted communication channel 135. In one embodiment, for example, one or more services may be provided to the user of HR 110 via one or more other user devices other than HR 110 (e.g., via one or more vehicle-based communications systems of a vehicle where HR 110 is implemented within a vehicle, via a smartphone of the user, via a computer of the user, and the like, as well as various combinations thereof). It will be appreciated that any other suitable service delivery platforms, as well as various combinations of such service delivery platforms, may be used for delivering services.

The services of services logic 133_{S} may include any services which may be provided based on one or more of user profile information from user profiles 133_{U}, feedback information received from HR 110 via targeted communication channel 135, and the like, as well as various combinations thereof. For example, the services of services logic 133_{S} may include one or more targeted content delivery services, a traffic condition alerting service, one or more recommendation services, and the like, as well as various combinations thereof.

Although depicted and described with respect to embodiments in which user profiles 133_{U}, analysis logic 133_{A}, audio content 133_{C}, and services logic 133_{S} each are stored within memory 132 of MS 130, it will be appreciated that such information may be stored in any other suitable manner (e.g., using any suitable number of databases internal to MS 130, using any suitable number of databases external to MS 130 and accessible to MS 130, on any suitable types and/or numbers of other network elements configured for hosting such information and making such information available to MS 130 for use in providing various targeted communication capabilities and/or processing such information for use in providing various targeted communication capabilities.

As described herein, MS 130 is configured for providing a targeted communication capability for a user. The MS 130 is configured for receiving feedback information associated with the user (e.g., from HR 110 via targeted communication channel 135 and/or any other suitable source), processing the feedback information (and/or other suitable information) for identifying targeted communication information for the user (e.g., to be provided to HR 110 and/or any other device associated with the user), and propagating the targeted communication information for the user (e.g., to HR 110 and/or any other device associated with the user). A description of various embodiments of feedback information and target communication information follows.

As described herein, feedback information is provided to MS 130, where it may be stored as part of user profiles 133, analyzed by analysis logic 133_{A} for purposes of determining targeted communication information to be provided to HR 110, and the like, as well as various combinations thereof.

The feedback information may include any suitable types of feedback information, which may depend on the purpose for which the feedback information is intended to be used (e.g., the service(s) for which the feedback information is intended to be used). The feedback information may be provided in any suitable manner, which may depend on the type of feedback information being provided (e.g., in response to manual user selections, automatically based on various trigger conditions, and the like, as well as various combinations thereof).

In one embodiment, feedback information may be provided from HR 110 to MS 130.

In one embodiment, feedback information provided from HR 110 to MS 130 via targeted communication channel 135 includes user feedback on audio content playing via HR 110. The user feedback on audio content playing via HR 110 may include any suitable information which may be provided at any suitable granularity and in any suitable manner. In one embodiment, for example, HR 110 may include LIKE and DISLIKE buttons which may be selected by the user of HR 110 as audio content is playing, for providing indications as to whether or not the user likes or dislikes the audio content playing via HR 110. The user feedback on audio content playing via HR 110 may include any other suitable information which may be provided at any suitable granularity and in any other suitable manner. As described herein, this type of feedback information may be used to select content to be provided to the user via HR 110, recommend content to the user via HR 110, provide and/or recommend services to the user via HR 110, and the like, as well as various combinations thereof.

In one embodiment, feedback information provided from HR 110 to MS 130 via targeted communication channel 135 includes user context information associated with the user of HR 110. For example, user context information may include information such as a physical location of the user (e.g., in their car, inside, outside, and the like), a geographic location of the user (at any suitable level, e.g., state, city, exact location, and the like), one or more characteristics of the geographic location of the user (e.g., hot or cold, forest or desert, and the like), a speed of the vehicle of the user (e.g., stuck in traffic, speeding on the open highway, and the like), a length of time left on a computed route expected to be followed by the user (e.g., based on a vehicle navigation system, navigation via a smartphone of the user, and the like), a mood of the user (e.g., which may be provided by the user via one or more user controls of user interface 116 of the HR 110), and the like, as well a various combinations thereof. As described herein, this type of feedback information may be used to select content to be provided to the user via HR 110 (which may include providing a context-based radio service targeted for the user), recommend content to the user via HR 110, provide and/or recommend services to the user via HR 110, and the like, as well as various combinations thereof.

In one embodiment, feedback information is provided to MS 130 from one or more other devices associated with the user of HR 110, e.g., from a smartphone of the user, from one or more on-board communication systems of a vehicle in which the HR 110 is disposed (e.g., on-board cellular phone capabilities, GPS tracking communications, and the like), from a computer of the user, and the like, as well as various combinations thereof. The feedback information may include any of the types of feedback information described as being provided from HR 110 to MS 130 and/or any other suitable feedback information.

The feedback information may include any other suitable type(s) of feedback information.

In such embodiments, the feedback information may be provided at any suitable time. For example, feedback information may be provided periodically, in response to various trigger conditions (e.g., which may be specific to the type of feedback information being provided), and the like, as well as various combinations thereof.

As described herein, MS 130 is configured to provide one or more services (e.g., based on user profile information, feedback information received via targeted communication channel 135, and the like, as well as various combinations thereof) using targeted communication channel 135

In one embodiment, the services include one or more targeted content delivery services, in which audio content is automatically selected for the user and delivered to the user based on some input information.

The audio content may be automatically selected for the user based on one or more of user personal information (e.g., gender, age, and the like), user preference information (e.g., preferred and/or non-preferred audio content types, audio content genres, audio content channels (e.g., radio stations, other audio channel types, and the like), audio content items, and the like, as well as various combinations thereof), user context information (e.g., physical location, geographical location, user mood, and the like, as well as various combinations thereof), and the like, as well as various combinations thereof. The information for use in automatically selecting audio content for the user may be received from any suitable source(s) of such information (e.g., from one or more of user profiles 133_{U}, via targeted communication channel 135, from other network elements, and the like, as well as various combinations thereof).

The audio content selected for the user may be selected using any suitable matching algorithm(s) configured for selecting audio content based on user profile information associated with the user. The selection of audio content may include one or more of selection of audio channels for the user (e.g., radio stations, audio channels playing specific genres of audio content, and the like), selections of content items for the user (e.g., specific songs, skits, audio books, and the like), and the like, as well as various combinations thereof. The selection of audio content for the user may be customizable in variety of ways (e.g., via indications of audio content to be included/excluded, genres of audio content to be included/excluded, types of audio content to be included/excluded, and the like, as well as various combinations thereof).

The audio content selected for the user is provided to the HR 110 via any suitable audio content delivery mechanisms (e.g., via broadcast channel 125, via targeted communication channel 135, and the like).

In one embodiment, the services include one or more targeted content information delivery services, in which information about available audio content is delivered to the user based on some input information. In one such embodiment, where audio content preference information is maintained for a user (e.g., user profile information, user feedback regarding audio content items that the user likes/dislikes, and the like), information about available audio content is delivered to the user via targeted communication channel 135. For example, the information about available audio content may include information identifying audio channels currently playing content that may be of interest to the user (e.g., favorite songs of the user, content in a favorite genre of the user, and the like). For example, when the user travels away from his or her home area (e.g., when traveling across the country), the information about available audio content may include information identifying which audio channels, in the area to which the user travels, typically play audio content that is most likely to be of interest to the user (e.g., FM channels, which are regional). The information about available audio content may include any other suitable information. The information about available audio content may be indicated to the user in any suitable format (e.g., via alerts presented via the HR 110 for notifying the user of the availability of the information about available audio content, via pop-ups presented via the HR 110 or any other associated display such that the user may review the information about available audio content, and the like, as well as various combinations thereof).

In one embodiment, the services include a traffic condition alerting service. In one such embodiment, users may provide feedback regarding potential traffic conditions to MS 130 (e.g., via targeted communication channels associated with their HRs), MS 130 identifies traffic conditions based on processing of potential traffic condition information reported by users, and MS 130 alerts users that will or may be impacted by identified traffic conditions. In one such embodiment, MS 130 also may provide content and/or recommendations to users alerted to traffic conditions (e.g., providing, via targeted communication channels and/or any other suitable communication channels (e.g., smartphone of the user), one or more of free audio content, audio content recommendations, incentives for the user to visit local businesses to wait until the traffic condition is resolved (e.g., coupons, discounts, and the like, for restaurants, stores, and other businesses), and the like, as well as various combinations thereof).

In one embodiment, the services include one or more recommendation services, whereby MS 130 identifies recommendations to make to the user of HR 110. In one embodiment, the recommendations may be provided in conjunction with other types of services described herein, e.g., recommending content similar to audio content that is provided to the HR 110 automatically under the control of MS 130, making recommendations in conjunction with a traffic condition alerting service (e.g., recommending content, businesses, and the like), and the like, as well as various combinations thereof. In one embodiment, recommendations may be provided as a standalone service that is not in conjunction with other types of services described herein. Various combinations of such recommendation-related embodiments may be provided.

The services may include any other services which may be provided using targeted communication channel 135 (e.g., using one or both of feedback information received via targeted communication channel 135 and targeted communication information provided via targeted communication channel 135). In one embodiment, MS 130 may be configured for providing one or more network management functions in conjunction with the targeted communication capability.

In one embodiment, for example, in which MS 130 provides content delivery and/or recommendation services, the MS 130 (or any other suitable device) may be configured for providing network traffic management in conjunction with the content delivery and/or recommendation services. For example, the MS 130 may be configured to provide network traffic management for the network supporting targeted communication channel 135. In one such embodiment, for example, content selected to be provided or recommended to the user of HR 110 may be selected based on at least one characteristic of the network supporting targeted communication channel 135. In one such embodiment, for example, selection of the content or content recommendations may be performed in a manner tending to increase the ratio of broadcast content to unicast content during high network load conditions. For example, where the ratio of broadcast to unicast content during normal load conditions is typically 70%/30%, the content selection/recommendation process may be configured to select content/content recommendations in a manner tending to change the ratio of broadcast to unicast content to 30%/70% during peak load hours on the network. Although primarily depicted and described with respect to use of specific network characteristics and broadcastlunicast content ratios, it will be appreciated that such traffic management may be performed within the context of a hybrid radio system using various other network characteristics and/or broadcastlunicast content ratios.

The MS 130 may be configured to provide any other suitable network management functions in conjunction with the targeted communication capability.

Although omitted for purposes of clarity, MS 130 may provide functions for one or more providers (e.g., content providers, service providers, and the like, as well as providers operating in multiple such roles). In various embodiments in which MS 130 is maintained by and/or accessible to multiple providers, user preference information of the users may be used across different services of single providers, across different providers, and the like, as well as various combinations thereof.

Although depicted and described with respect to embodiments in which the targeted communication capability is provided using communications between HR 110 and MS 130, it will be appreciated that HR 110 may communicate with any other suitable network elements for purposes of providing various targeted communication capabilities depicted and described herein (e.g., other control systems configured for receiving and storing and/or processing feedback information received from HR 110 via targeted communication channel 135, other audio content sources configured for providing audio content via targeted communication channel 135, and the like, as well as various combinations thereof). In this sense, various capabilities depicted and described herein as being performed by MS 130 may be distributed across one or more other systems (in addition to and/or in place of MS 130) and/or may be provided using one or more other systems. Furthermore, in this manner, targeted communications channel 135 may be considered to represent multiple communication channels which may be supported between HR 110 and one or more other devices.

FIG. 2 depicts one embodiment of a method for providing targeted communications in the hybrid radio communications system of FIG. 1. As depicted in FIG. 2, a portion of the steps of method 200 are performed by HR 110 and a portion of the steps of method 200 are performed by MS 130. Thus, it will be appreciated that although depicted as a single method, method 200 may be implemented as a process running on HR 110 and a process running on MS 130 and, thus, may be viewed as two different cooperating processes.

At step 202, method 200 begins. At step 204, HR 110 transmits feedback information to MS 130 via a targeted communication channel. At step 206, MS 130 receives the feedback information (e.g., user preference information, user context information, and the like) from the HR 110 via the targeted communication channel. At step 208, MS 130 determines targeted communication information (e.g., content, services, recommendations, and the like) using the feedback information. At step 210, MS 130 transmits the targeted communication information to HR 110 via the targeted communication channel. At step 212, HR 110 receives the targeted communication information from MS 130 via the targeted communication channel. At step 214, HR 110 presents the targeted communication information (e.g., plays audio content, presents information associated with a service, presents recommendations for review, and the like). At step 216, method 200 ends.

Although primarily depicted and described with respect to an embodiment in which targeted communication information is determined based on feedback information, it will be appreciated that method 200 may be adapted such that targeted communication information may be determined using any other suitable information received from any other suitable source, where the other information may be in addition to or in place of the feedback information received via the targeted communication channel.

Although primarily depicted and described with respect to an embodiment in which the targeted communication information is provided to HR 110 from MS 130, it will be appreciated that method 200 may be adapted such that targeted communication information may be provided to HR 110 from any other suitable source of targeted communication information (e.g., where HR 110 interacts with a server or device other than MS 130, where MS 130 instructs another server or device to propagate targeted communication information to HR 110, and the like, as well as various combinations thereof).

As described herein, the targeted communication capability may include various other associated capabilities, which may be provided in conjunction with the hybrid radio capability and/or independent of the hybrid radio capability. For example, the targeted communication capability may include one or more of a context-based radio capability, a real-time traffic condition alerting capability, an Internet-based radio capability, a video-based targeted communication capability, and the like, as well as various combinations thereof.

In one embodiment, a context-based radio capability is provided.

The context-based radio capability may be provided within the context of the hybrid radio capability depicted and described with respect to FIGS. 1 and 2 or using any other suitable radio environment (e.g., a traditional radio environment, an Internet-based radio environment, and the like, as well as various combinations thereof).

The context-based radio capability enables an immersive radio experience for users, thereby creating an optimum user experience and enabling various brands to engage with existing and potential customers and establish and maintain a lasting relationship and to establish and maintain a lasting image for the brands.

The context-based radio capability is configured to automatically adjust the audio content being provided to a user based on user context information associated with the user.

As described herein, adjustment of the audio content being provided to a user via a radio (e.g., HR 110) may be performed by a management system processing the user context information (e.g., MS 130).

As described herein within the context of the hybrid radio capability, for example, user context information may include information such as a physical location of the user (e.g., in their car, inside, outside, and the like), a geographic location of the user (at any suitable level; e.g., state, city, exact location, and the like), one or more characteristics of the geographic location of the user (e.g., hot or cold, forest or desert, and the like), a mood of the user, a time of day at the location of the user, and the like.

As described herein within the context of the hybrid radio capability implemented using a hybrid radio within a vehicle, for example, user context information also may include information such as a speed of the vehicle of the user (e.g., stuck in traffic, speeding on the open highway, and the like), a length of time left on a computed route expected to be followed by the user (e.g., based on a vehicle navigation system, navigation via a smartphone of the user, and the like), and the like, as well a various combinations thereof.

As further described herein within the context of the hybrid radio capability, the user context information may be obtained by the management system from any suitable source(s) of such information. For example, at least a portion of the information may be included within a network-based user profile of the user, received as real-time feedback information via a targeted communication channel from a user device of the user (e.g., a hybrid radio, a smartphone of the user, and the like). Similarly, for example, in the case of a hybrid radio of a vehicle, the user context information may be obtained by the hybrid radio, for transmission via a targeted communication channel, from any suitable source of the information (e.g., determining user location information from the GPS system of the vehicle, determining route information from a navigation system of the vehicle, determining speed information from a speed monitoring system of the vehicle, and the like, as well as various combinations thereof).

In one embodiment, the context-based radio capability may automatically adjust the audio content being provided to a user based on other types of information in addition to the user content information (e.g., personal information of the user, user preference information, the audio content listening behavior of the user, and the like, as well as various combinations thereof).

In one embodiment of the context-based radio capability, the user selects an audio channel associated with a category of audio content. The category may be any suitable granularity (e.g., music versus comedy skits, a genre of music, music of a particular artist or group of artists, and the like). The audio channel then provides music of the selected category to the radio of the user in a seeming random manner (e.g., one audio content item after another); however, the audio content being played via the selected audio channel is not random. Rather, the audio content that is played via the selected audio channel is based on the user content information (e.g., location, time of day, mood, and the like) and, optionally, other types of information which may be considered in selecting audio content to be played to the user via the selected audio channel (e.g., gender, age, and the like).

For example, the user may select a country music channel. In this case, unlike a broadcast channel that plays country music (where the user has no control over the songs being played), the country songs played via the country music channel are selected based on the user context information of the user (e.g., playing fast songs at night to help keep the user alert while driving, playing popular songs when the user is stuck in traffic, playing happy songs when the user indicates that he or she is in a bad mood, and the like).

Similarly, for example, the user may select a comedy channel. In this case, again, unlike a broadcast channel that plays comedy skits (where the user has no control over the content being played), the comedy content played via the comedy channel is selected based on the user context information of the user (e.g., playing short skits when the route information of the user indicates that he or she has almost reached his or her destination, playing content suitable for children when the user indicates that children are in the vehicle, and the like).

In this manner, the context-based radio capability provides the user with a personalized, immersive radio experience. By matching the infotainment being played with the current context of the user, a more immersive and pleasurable experience is created for the user as compared to existing radio systems that merely play a fixed list of songs.

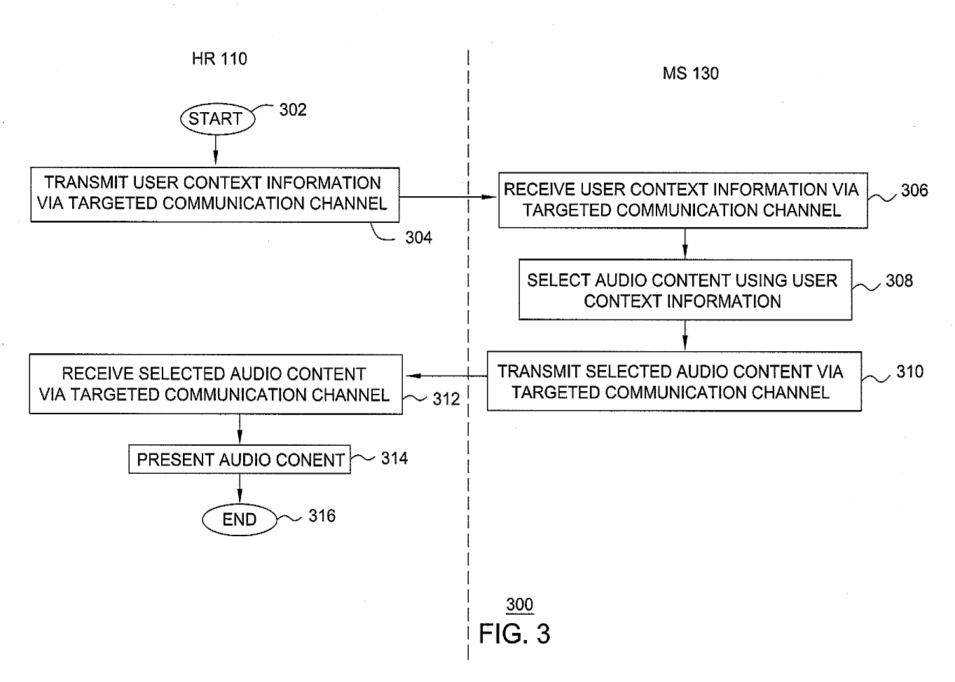

FIG. 3 depicts one embodiment of a method for providing a context-based radio capability in the hybrid radio communications system of FIG. 1. As depicted in FIG. 3, a portion of the steps of method 300 are performed by HR 110 and a portion of the steps of method 300 are performed by MS 130. Thus, it will be appreciated that although depicted as a single method, method 300 may be implemented as a process running on HR 110 and a process running on MS 130 and, thus, may be viewed as two different cooperating processes.

At step 302, method 300 begins. At step 304, HR 110 transmits user context information to MS 130 via a targeted communication channel. At step 306, MS 130 receives the user context information (e.g., user preference information, user context information, and the like) from the HR 110 via the targeted communication channel. At step 308, MS 130 selects audio content for the user using the use context information. At step 310, MS 130 transmits selected audio content to HR 110 via the targeted communication channel. At step 312, HR 110 receives the audio content from MS 130 via the targeted communication channel. At step 314, HR 110 presents the audio content. At step 316, method 300 ends.

Although primarily depicted and described with respect to an embodiment in which the selected audio content is provided to HR 110 from MS 130, it will be appreciated that method 300 may be adapted such that audio content selected using user context information may be provided to HR 110 from any other suitable source of audio content (e.g., where HR 110 interacts with a server or device other than MS 130, where MS 130 instructs another server or device to propagate selected audio content to HR 110, and the like, as well as various combinations thereof).

Although primarily depicted and described herein with the context of using user context information to provide a context-based radio capability, it will be appreciated that, in other embodiments, user context information may be used to provide other types of capabilities, which may involve providing other types of content and infotainment via other types of content distribution platforms. For example, user context information may be used to provide targeted delivery of video content (e.g., video-on-demand content, Internet-based video content, and the like) to the user (e.g., via a television distribution network, the Internet, and the like, where at least a portion of the user context information may be received via those content delivery platforms, from a smartphone of the user, from a hybrid radio, and/or from any other suitable device associated with the user). For example, user context information may be used to provide targeted delivery of video-based content to the user (e.g., videos, multimedia content including video, and the like). For example, user context information may be used to provide targeted delivery of mobile applications to the user (e.g., via a smartphone of the user, where at least a portion of the user context information may be received from the smartphone, from a hybrid radio, and/or from any other suitable device associated with the user). For example, user context information may be used to provide targeted delivery of recommendations to the user (e.g., content recommendations, advertisements, and the like). In other words, user context information may be utilized to provide targeted delivery of any suitable content types via any suitable content distribution platforms.

In one embodiment, a real-time traffic condition alerting capability or service is provided, for providing users with relevant real-time traffic alerts.

The real-time traffic condition alerting capability may be provided within the context of the hybrid radio capability depicted and described with respect to FIGS. 1 and 2 or in any other suitable communications environment.

In one embodiment, the real-time traffic condition alerting capability is provided for a user using a user device, which may be any suitable user device (e.g., smartphone of the user, a vehicle-based communication system of the user, and the like, as well as various combinations thereof). In one embodiment, the real-time traffic condition alerting capability is provided using a traffic condition tracking system, which may be implemented in any suitable manner. In one embodiment, for example, the traffic condition tracking system is implemented as part of, or in a manner similar to, the MS 130 depicted and described with respect to FIG. 1 (e.g., with information for the real-time traffic condition alerting capability being exchanged between the traffic condition tracking system and user devices via targeted communication channel 135). The traffic condition tracking system may be implemented in any other suitable manner.

In one embodiment, relevant real-time traffic alerts are provided to users by tracking the locations of users and processing traffic reports from the users in order to detect traffic conditions at specific locations and notify users with real-time traffic alerts when detected traffic conditions will or may impact the users.

In general, a traffic condition may be any type of condition which will or may be of interest to users (e.g., dangerous traffic, heavy traffic, traffic jams, and the like).

In general, a traffic report provided by or on behalf of a user is a report indicative of the presence of a traffic condition or, in some cases, a potential traffic condition, such that a threshold number of such traffic reports at a particular location indicates the occurrence or likely occurrence of an actual traffic condition at or near that particular location. It will be appreciated that references herein to providing a traffic report also may be considered to be reporting a traffic condition or potential traffic condition.

The detection of a traffic condition may be determined in any suitable manner.

In one embodiment, the detection of a traffic condition at a particular location is made in response to a determination that a threshold number of users provide traffic reports reporting a traffic condition at or near a particular location.

In such embodiments, a traffic report may be provided in any suitable manner.

In one embodiment, reporting of a traffic condition (i.e., providing a traffic report) may include providing an indication of identification of a traffic condition.

In one embodiment, a traffic report provided by or on behalf of a user does not include information identifying a location of the user at the time of providing of the indication of the identification of the traffic condition. This may be used where the locations of users are being monitored, such that reporting of the location of the user along with the reporting of the traffic condition is redundant.

In one embodiment, a traffic report provided by or on behalf of a user also includes information identifying a location of the user at the time of providing of the indication of the identification of the traffic condition. This also may be used where the locations of users are being monitored. This embodiment may ensure more accurate traffic condition location reporting by capturing the location of the user at or near the instant when the indication of the traffic condition is initiated by or on behalf of the user.

In one embodiment, a traffic report provided by or on behalf of a user may include additional information which may be relevant to the traffic condition being reported. For example, such additional information may include one or more of a type of traffic condition (e.g., heavy traffic, dangerous road conditions, accident, detour, and the like), average speed experienced as a result of the traffic condition, an expected delay time due to the traffic condition, and the like, as well as various combinations thereof.

The reporting of a traffic condition may be performed in any suitable manner.

In one embodiment, for example, a smartphone of a user may be configured to provide a traffic report reporting a traffic condition.

In one embodiment, for example, a mobile application available on the smartphone may be configured to provide an indication of identification of a traffic condition and the GPS capabilities of the smartphone may be used to provide a location of the user at the time of providing of the indication of the identification of the traffic condition.

In one embodiment, the mobile application may be activated manually by the user (e.g., before the user begins driving, when the user encounters the traffic condition and would like to report it, or at any other suitable time). In one embodiment, the mobile application may be activated automatically (e.g., when the GPS unit of the smartphone detects a significant slowdown of the vehicle, when a GPS unit of the vehicle reports a significant slowdown of the vehicle to the smartphone of the user, when a speed monitoring system of the vehicle reports a significant slowdown of the vehicle to the smartphone of the user, and the like).

In one embodiment, one or more capabilities of the mobile application may be activated manually and/or automatically. In one embodiment, for example, a REPORT TRAFFIC JAM button may be displayed on the smartphone in response to a manual and/or an automatic trigger condition. In one embodiment, for example, a voice recognition capability of the smartphone may be activated in response to a manual and/or an automatic trigger condition. As described herein, in such embodiments the trigger condition may be one or more of a menu selection by the user, detection by the smartphone (e.g., directly or via reporting from a system of the vehicle) of a significant slowdown of the vehicle, and the like, as well as various combinations thereof.

In one embodiment, reporting of an indication of a traffic condition via a mobile application may be initiated manually by the user. The user may initiate reporting of the indication of a traffic condition via a mobile application in any suitable manner, which may depend on the type of reporting capabilities enabled on the smartphone for the user for traffic condition reporting purposes. For example, the user may initiate reporting of the indication of the traffic condition via the mobile application by selecting a REPORT TRAFFIC JAM button or other similar user controls displayed by the mobile application via the smartphone, by speaking one or more keywords which trigger reporting of the indication of the traffic condition (e.g., the driver stating “traffic jam” or any other suitable word or phrase), and the like.

In one embodiment, reporting of an indication of the traffic condition via a mobile application may be initiated automatically by the mobile application. The mobile application may initiate reporting of the indication of the traffic condition in any suitable manner, which may depend on the type of reporting capabilities enabled on the smartphone for traffic condition reporting purposes. For example, the mobile application may initiate reporting of the indication of the traffic condition automatically in response to detection by the smartphone (e.g., directly or via reporting from a system of the vehicle) of a significant slowdown of the vehicle, in response to a determination by the smartphone that the user has moved less than a threshold distance in a certain length of time, and the like.

The use of a smartphone of a user to report a traffic condition may be implemented in any other suitable manner.

In one embodiment, for example, enhanced, and/or new capabilities of a vehicle of a user may be used to report a traffic condition. It will be appreciated that, as in the case of use of a smartphone of a user to report a traffic condition, reporting of a traffic condition using capabilities of a vehicle may be implemented in any suitable manner (e.g., via manual or automatic initiation, in response to any suitable trigger conditions, and the like, as well as various combinations thereof).

In one embodiment, for example, enhanced, and/or new capabilities of a vehicle of a user may be used to provide an indication of identification of a traffic condition and the GPS capabilities of the vehicle may be used to provide a location of the user at the time of providing of the indication of the identification of the traffic condition.

In one embodiment, for example, a system or program available within a processor of the vehicle may be configured to provide an indication of the identification of a traffic condition and the GPS capabilities of the vehicle may be used to provide a location of the user at the time of providing of the indication of the identification of the traffic condition.

In one embodiment, the program of the vehicle that is used for reporting a traffic condition may be activated manually by the user (e.g., before the user begins driving, when the user encounters the traffic condition and would like to report it, or at any other suitable time). In one embodiment, the program of the vehicle that is used for reporting a traffic condition may be activated automatically (e.g., when the GPS unit of the vehicle detects a significant slowdown of the vehicle, when a GPS unit of a smartphone of the user reports a significant slowdown of the vehicle to the vehicle, and the like).

In one embodiment, one or more capabilities of the program of the vehicle that is used for reporting a traffic condition may be activated manually and/or automatically. In one embodiment, for example, a REPORT TRAFFIC JAM button may be displayed on a display screen of the vehicle (e.g., radio display, navigation display, and the like) in response to a manual and/or an automatic trigger condition. In one embodiment, for example, a voice recognition capability of the vehicle may be activated in response to a manual and/or an automatic trigger condition. As described herein, in such embodiments the trigger condition may be one or more of a menu selection by the user, detection by the vehicle (e.g., via GPS capabilities of the vehicle or via reporting from a smartphone of the user) of a significant slowdown of the vehicle, and the like, as well as various combinations thereof.

In one embodiment, reporting of identification of a traffic condition via the vehicle may be initiated manually by the user. The user may initiate reporting of identification of the traffic condition via the vehicle in any suitable manner, which may depend on the type of reporting capabilities available in the vehicle for traffic condition reporting purposes. In one embodiment, for example, a button or other suitable user control may be actuated by a user for reporting identification of a traffic condition. In one embodiment, for example, selection of a user control associated with a radio of the vehicle may initiate reporting of identification of a traffic condition (e.g., selection of a new button available on the radio, selection of a touch screen control displayed on a display of the radio, and the like). In one embodiment, for example, selection of a user control associated with a navigation system of the vehicle may initiate reporting of identification of a traffic condition (e.g., selection of a new button available on the navigation interface, selection of a touch screen control displayed on a display associated with the navigation system, and the like). In one embodiment, for example, actuation of the hazard lights of the vehicle (often used by drivers in many countries to warn other drivers of traffic jams and other conditions) may initiate reporting of identification of a traffic condition. In one embodiment, for example, flashing of the headlights on and off in quick succession (often used by drivers in many countries to warn other drivers of traffic jams and other conditions) may initiate reporting of identification of a traffic condition. In one embodiment, vehicles may be equipped with new TRAFFIC JAM reporting buttons configured for use in initiating reporting of identification of a traffic condition. It will be appreciated that various other enhanced and/or new capabilities of a vehicle of a user may be used to report a traffic condition.

In one embodiment, reporting of identification of a traffic condition via the vehicle may be initiated automatically by the vehicle. The vehicle may initiate reporting of identification of the traffic condition in any suitable manner, which may depend on the type of reporting capabilities enabled on the vehicle for traffic condition reporting purposes. For example, the vehicle may initiate reporting of identification of the traffic condition automatically in response to detection by the smartphone (e.g., directly or via reporting from a system of the vehicle) of a significant slowdown of the vehicle, in response to a determination by the smartphone that the user has moved less than a threshold distance in a certain length of time, and the like.

In such embodiments, the indication of the identification of the traffic condition, and the associated location of the user at the time of initiation of the indication of the identification of the traffic condition, may be communicated to the network in any suitable manner (e.g., using any suitable communications interfaces, any suitable formatting for the reported information, and the like, as well as various combinations thereof). In one embodiment, for example, the indication of the identification of the traffic condition, and the associated location of the user at the time of initiation of the indication of the identification of the traffic condition, may be communicated to the network via wireless communication capabilities of the smartphone (e.g., via a cellular network, via a WiFi network, and the like). In one embodiment, for example, the indication of the identification of the traffic condition, and the associated location of the user at the time of initiation of the indication of the identification of the traffic condition, may be communicated to the network via wireless communication capabilities integrated within the vehicle of the user.

The reporting of a traffic condition may be performed in any other suitable manner.

As traffic conditions are reported by and/or on behalf of users, the traffic condition tracking system tracks the locations of users and processes traffic reports provided by the users in order to detect traffic conditions at specific locations and notify users with real-time traffic alerts when detected traffic conditions will or may impact the users.

The detection of a traffic condition at a specific location, based on traffic reports provided by users (i.e., traffic conditions and potential traffic conditions reported by users), may be performed in any suitable manner. In one embodiment, a traffic condition is detected at a specific location when a threshold number of users report a traffic condition at the specific location. In one such embodiment, different locations may have different thresholds associated therewith (e.g., different locations may accommodate different amounts of traffic and, thus, the particular number of reported traffic conditions at one location may indicate a traffic jam while the same number of reported traffic conditions at another location may not indicate a traffic jam).

The locations of the users may be tracked in any suitable manner. In one embodiment, for example, in which the traffic condition alerting capability is implemented using a mobile application of a smartphone, the mobile application may periodically report the location of the user based on GPS information available on the smartphone. In one embodiment, for example, in which the traffic condition alerting capability is implemented using a program or application running within the vehicle of the user, the program or application of the vehicle may periodically report the location of the user based on GPS information available on the vehicle (e.g., reporting via a communication system of the vehicle, reporting by communicating the location to a smartphone of the user which may then report the location, and the like).

In one embodiment, in addition to the location of a user, additional relevant information may be provided to the traffic condition tracking system for purposes of alerting the user with real-time traffic alerts when detected traffic conditions will or may impact the users. For example, the additional information may include a direction of travel, information indicative of a specific route expected to be followed by the user (e.g., based on direction information from a navigation capability of the smartphone and/or a navigation system of the vehicle where the user has mapped a route to be followed), and the like, as well as various combinations thereof.

The traffic condition tracking system, having information indicative of the current locations of users (and, optionally, additional travel-related information such as direction of travel, expected route, and the like) and information identifying detected traffic conditions, is able to determine, in real time, when a traffic condition will or may impact users and, thus, may notify those users with real-time traffic alerts when detected traffic conditions will or may impact those users. The traffic condition tracking system may identify users impacted by or likely to be impacted by a traffic condition in any suitable manner. In one embodiment, for example, any user identified as being within a certain distance from a traffic condition is notified of the traffic condition. In one embodiment, for example, any user identified as being on the particular road experiencing the traffic condition is notified of the traffic condition. In one embodiment, any user identified as being on the particular road experiencing the traffic condition or any road adjacent to that particular road is notified of the traffic condition. It will be appreciated any other suitable types of information, as well as combinations of such types of information, may be used for identifying users impacted by or likely to be impacted by a traffic condition.

The traffic condition tracking system having information indicative of the current locations of users (and, optionally, additional travel-related information such as direction of travel, expected route, and the like) and information identifying detected traffic conditions, also may perform other types of processing.

In one embodiment, for example, the traffic condition tracking system may correlate detected traffic conditions with current road maps, such that real-time traffic alerts provided to the users may include indications of the location of the traffic condition and potential alternate routes.

In one embodiment, for example, the traffic condition tracking system may correlate detected traffic conditions with historical traffic condition information, which may be used for various purposes. In one embodiment, for example, this type of mapping may be performed such that the real-time traffic alerts provided to the users may include indications as to whether the traffic condition is typical for that location (e.g., that intersection is usually congested at the current time of day, that highway is usually congested on that day of the week, and the like). In one embodiment, for example, this type of mapping may be performed such that the traffic condition tracking system may alert the appropriate authorities to uncommon traffic conditions (e.g., historical data indicates that traffic conditions are not common in that location at that time) at which police, ambulance, fire, and/or other types of responders may be needed.

The traffic condition tracking system may perform other types of processing using such information. The traffic condition tracking system may notify a user with a real-time traffic alert in any suitable manner.

The real-time traffic alert may be provided to any suitable device for presenting the real-time traffic alert to the user (which may or may not be the device used by the user to report traffic conditions). In one embodiment, for example, in which the traffic condition alerting capability is implemented using a mobile application of a smartphone, the real-time traffic alert may be provided to the mobile application. In one embodiment, for example, in which the traffic condition alerting capability is implemented using a program or application running within the vehicle of the user, the real-time traffic alert may be provided to the program or application on the vehicle. In one embodiment, for example, the real-time traffic alert may be provided to any suitable device of the user independent of the manner in which traffic conditions are reported by the user (e.g., via a cellular phone of the user, via a smartphone of the user, via a system of the vehicle, via a navigation system (e.g., integrated with the vehicle or portable), and the like, as well as various combinations thereof).

The real-time traffic alert may include any suitable information. For example, the real-time traffic alert may include information identifying the location of the traffic condition, the expected delay due to the traffic condition, the cause of the traffic condition, proposed alternate routes for avoiding the traffic condition, and the like, as well as various combinations thereof.

The real-time traffic alert may be provided in any suitable format, such that it may be presented in any suitable format. For example, the real-time traffic alert may be provided using one or more of text, audio, video, and like content types suitable for use in providing real-time traffic alerts.

The real-time traffic alert provided by the traffic condition tracking system, for notifying the user when a detected traffic condition will or may impact the user, may be presented to the user in any suitable manner, which may depend on the device to which the real-time traffic alert is provided.

As indicated above, the real-time traffic alert may be provided to any suitable device of the user and, thus, may be presented via any suitable device of the user.

Similarly, as described above, the real-time traffic alert may be presented in any suitable format (e.g., via text, audio, video, like content types suitable for use in presenting real-time traffic alerts). For example, the real-time traffic alert may be a message spoken by a human voice (pre-recorded). For example, the real-time traffic alert may be a video showing a person discussing information about the traffic condition. The use of such messages will attract the attention of the users, thereby preventing the users from becoming “numb” to the real-time traffic alerts (and, thus, possibly ignoring the real-time traffic alerts).

The notification of users with real-time traffic alerts when detected traffic conditions will or may impact the users may be performed in any other suitable manner.

In one embodiment, in conjunction with providing a user with a relevant real-time traffic alert, the user also may be provided with relevant targeted communication information (e.g., content, services, recommendations for content and/or services, and the like, as well as various combinations thereof).

In one embodiment, in conjunction with providing a user with a relevant real-time traffic alert, the user may be provided with a recommendation for activity for the user during the delay expected to result from the traffic condition. The recommendation for activity may be any suitable recommendation which may be presented to the user and which the user may review and act upon during the delay expected to result from the traffic condition. In one embodiment, for example, the recommendation may be a recommendation for the user to purchase content for consumption during the expected delay (e.g., recommending a song, an album, a television program, a movie, a movie trailer, a mobile application, and the like). For example, the user may receive a message such as: “since you are stuck in traffic for an expected 20 minutes, why not listen to the first chapter of a book” which also may include a link to an audio content store via which the user may purchase the recommended book, or any other available audio content, for consumption while the user is delayed by the traffic condition. It will be appreciated that this is merely one example of the type of message which may be presented to the user and associated type of content which may be recommended to the user.

In one embodiment, for example, the recommendation may be a recommendation for the user to stop at a nearby restaurant to have a meal while waiting for the traffic condition to clear up. For example, the user may receive a message such as: “here is a 10% discount coupon for your favorite burger restaurant just down the road; you might as well have some lunch while waiting.” The user could then bring the 10% discount coupon to the burger restaurant and relax and eat while waiting for the traffic condition to clear. It will be appreciated that this is merely one example of the type of message which may be presented to the user and associated business (and offer) which may be presented to the user.

The recommendation may be any other suitable type of recommendation for activity which may occupy the user during the expected delay, and, optionally, which may generate, or least tend to or attempt to generate, revenue for one or more associated parties (e.g., content providers, nearby businesses, advertisers, and the like).

In one embodiment, the recommendation selected for the user may be selected based on the expected length of the delay. For example, the expected length of the delay may be used to select a content item(s) having a similar duration (e.g., selecting a first chapter of an audio book having a similar duration, selecting a television program having a similar duration where it is determined that it would be safe for the user to watch the video, and the like). For example, the expected length of the delay may be used to select an activity to be recommended to the user (e.g., recommending stopping at a fast-food restaurant when the delay is expected to relatively short, recommending stopping at a shopping mall when the delay is expected to be relatively long, and the like). In this manner, targeted advertising may be targeted based on the expected length of the delay.

In such embodiments, the recommendation may be provided to the user in any suitable manner. For example, the recommendation may be provided to the user as part of the real-time traffic alert provided to the user, separate from the real-time traffic alert provided to the user, and the like, as well as various combinations thereof.

The traffic condition reporting capability provides significant improvement over typical traffic condition reporting. For example, radio stations report traffic condition information using radio broadcasts that have limited relevance due to the large broadcast ranges of the radio stations (i.e., many of the listed traffic jams are irrelevant to the user, which may cause the user to miss information about traffic conditions that may in fact be relevant. Similarly, for example, due to processing delays, radio stations may continue to report traffic jams that no longer exist and/or new traffic jams are not reported because they did not exist when the list of traffic jams was prepared to be read on the radio. These and various other deficiencies of typical traffic condition reporting schemes are overcome via use of the traffic condition reporting capability. The traffic condition reporting capability provides drivers with more accurate and relevant information about traffic conditions, improves safety conditions by warning drivers about traffic conditions (e.g., warnings avoid collisions which may result from rapid slowdown required when approaching a traffic jam), provides radio stations with better traffic condition reporting service and thus better brand recognition, provides various business players with various business opportunities (e.g., providing content owners and/or nearby businesses with access to additional customers or at least to potential customers, providing advertisers with various targeted advertising opportunities, and the like), and may provide various other benefits.

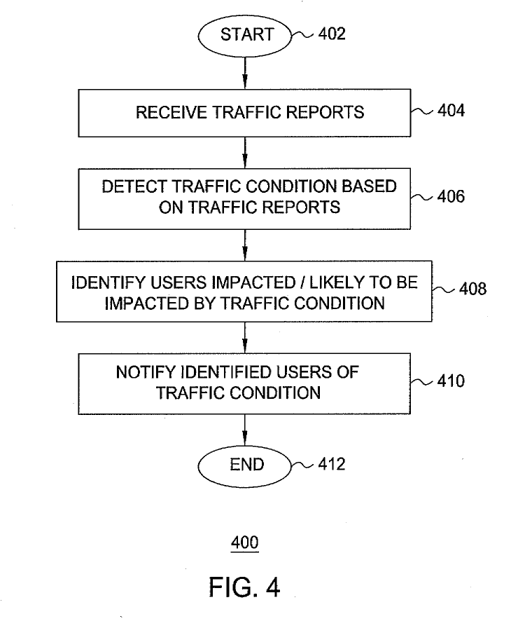

FIG. 4 depicts one embodiment of a method for providing a real-time traffic condition alert capability. The method 400 of FIG. 4 may be performed by a traffic condition tracking system or any other suitable device.

At step 402, method 400 begins. At step 404, traffic reports are received. At step 406, a traffic condition is detected based on the traffic reports. At step 408, users impacted or likely to be impacted by the detected traffic condition are identified. At step 410, the identified users are notified of the traffic condition. At step 412, method 400 ends.

Although depicted and described as ending (for purposes of clarity), it will be appreciated that method 400 will continue to be performed for receiving and processing traffic reports for identifying traffic conditions, as well as for identifying users impacted or likely to be impacted by the traffic conditions and alerting the identified users to the identified traffic conditions.

Although omitted for purposes of clarity, it will be appreciated that method 400 may be modified such that any suitable targeted communication information (e.g., content, services, recommendations, and the like) may be provided to one or more users notified of the traffic condition.

As described herein, the hybrid radio capability and related capabilities (e.g., the context-based radio capability, the real-time traffic condition alerting capability, and the like) may be provided in various combinations. In such embodiments, the various capabilities may be relatively loosely integrated (e.g., implemented within the same device but not controlled via the same control program(s)) or relatively tightly integrated (e.g., controlled via a program or programs cooperating to provide access to such capabilities for users). As also described herein, the various capabilities may be controlled using various types of user controls. In at least some embodiments in which such capabilities are more tightly integrated (and, thus, user controls may be more tightly integrated), the user controls for the various capabilities may be modified automatically based on context. In one embodiment, for example, in which at least a portion of the user controls are displayed via a touch screen, at least a portion of the displayed user controls may changed based on context. An example may be where a user is driving a car having a hybrid radio supporting various capabilities depicted and described herein. In this example, while driving normally, the touch screen icons would include a ZAP icon for switching between stations (and, optionally, LIKE and/or DISLIKE icons for providing feedback on the content that is currently playing). In this example, when a possible traffic jam is detected, the ZAP icon would automatically turn into a REPORT TRAFFIC JAM icon for enabling the user to report the traffic jam. In this example, after the user selects the REPORT TRAFFIC JAM button, the REPORT TRAFFIC JAM icon would be replaced again with the ZAP icon (and, optionally, other icons). In this example, when an incoming call is received, the ZAP icon would automatically turn ACCEPT CALL and REJECT CALL icons for enabling the user to accept or reject the call. In this example, when a recommendation is received, the ZAP icon would automatically turn into a SWITCH icon for enabling the user to switch to the recommended content. In this example, when an advertisement is received, the ZAP icon would automatically turn into a PURCHASE icon for enabling the user to purchase the advertised content. In one embodiment, changes of the user controls may be accompanied by audible alerts. Although primarily depicted and described with respect to replacement of certain icons with other icons, it will be appreciated that any other suitable icon management schemes may be used for providing similar capabilities (e.g., icons are displayed in addition to existing icons rather than replacing existing icons, displayed icons are removed or hidden when no longer applicable based on the current context, and the like). It will be appreciated that various combinations of such schemes may be used.

In one embodiment, an Internet-based radio capability is provided.

In one embodiment, the Internet-based radio capability may be provided independent of the hybrid radio capability depicted and described with respect to FIGS. 1 and 2.

In one embodiment, the Internet-based radio capability may be provided in conjunction with the hybrid radio capability depicted and described with respect to FIGS. 1 and 2.

The Internet-based radio capability is adapted for combining the traditional radio experience with features of the Internet in a simple and user-friendly manner, thereby reinvigorating radio, which is a dying communication medium (e.g., existing radio has a declining audience as younger generations are not in the habit of listening to radio anymore, and existing radio is ubiquitous and provides a consistent experience but is not personalized).

The Internet-based radio capability enables blending of radio communications with user information (e.g., user habits, user preferences, and the like, as well as various combinations thereof).

The Internet-based radio capability enables initiation of interaction with consumers and communication with consumers in a personalized, interactive, targeted manner, thereby creating an optimum user experience, at the right place and time, to enable various brands to engage with existing and potential customers and establish and maintain a lasting relationship.

The Internet-based radio capability provides a uniform, elegant, simple, unobtrusive user experience that is consistent across all user devices and situations in which the users utilize radio content, thereby creating ideal channels for enabling various brands to communicate their messages and build their images.

The Internet-based radio capability may be supported by and/or accessed from any suitable computing device (e.g., a desktop computer, a laptop computer, a notebook, a subnotebook, a smartphone, a cellular phone, or any other suitable device on which the Internet-based radio capability may be supported and/or from which the Internet-based radio capability may be accessed).

Thus, the Internet-based radio capability creates a unique, compelling, consistent new kind of radio experience that users will enjoy, content providers (e.g., radio operators) will want to deploy, and premium brands will want to leverage.

In one embodiment, an audio content website is provided for enabling users to search for, locate, and request audio channels and other audio content.

In one embodiment, the audio content website is designed in a manner for attracting and maintaining an audience (e.g., by making the website easy to understand and easy to use, omitting elements which tend to distract users (e.g., advertisements, banners, and like elements which would distract from the primary purpose of the website, which is to attract an audience for the website). In this manner, the audio content website is configured for providing a natural appeal to many users for attracting users to the website, and for providing a compelling user experience to those users that use the website.

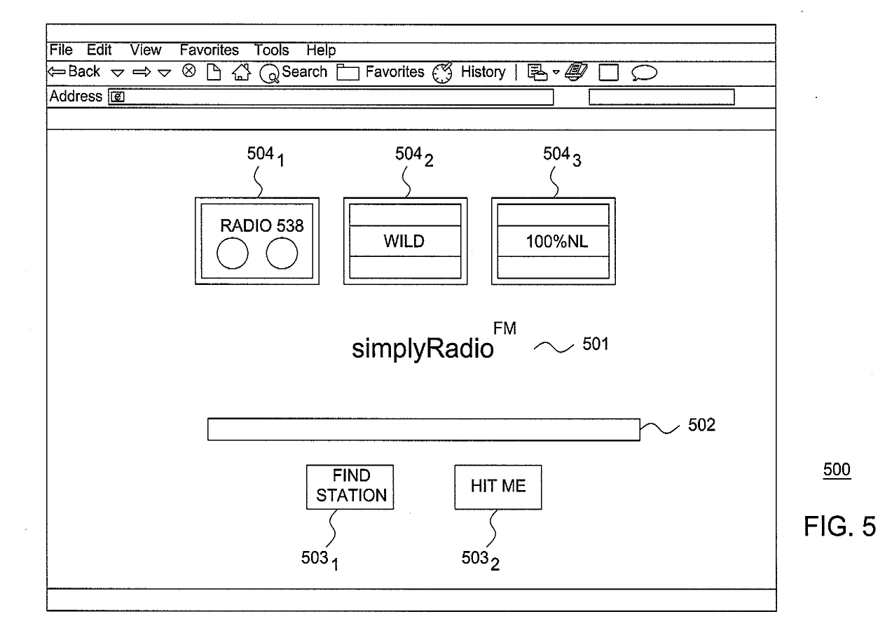

An exemplary design for the audio content website interface page is depicted in FIG. 5. It will be appreciated that this design is merely exemplary, and that any other suitable design may be used.

FIG. 5 depicts an exemplary audio content website interface page for the Internet-based radio capability.

The exemplary audio content website interface page 500 is a main page of an associated audio content website hosted on one or more servers in the network.

As depicted in FIG. 5, the exemplary audio content website interface page 500 includes a website name 501, a search bar 502, a pair of control buttons 503₁ and 503₂ (collectively, control buttons 503) associated with search bar 502, and three channel bookmark icons 504₁-504₃ (collectively, channel bookmark icons 504).

The website name 501 of exemplary audio content website interface page 500 is simplyRadio™, although it will be appreciated that any suitable name may be used. Similarly, it will be appreciated that the name may be positioned in any suitable location on the exemplary audio content website interface page 500.

The search bar 502 and associated control buttons 503 of exemplary audio content website interface page 500 enable the user to perform actions such as searching for radio stations, searching for audio content channels, requesting audio content selected for the user (e.g., based on personal user information, user preference information, user context information, and the like, as well as various combinations thereof), and like actions, as well as various combinations thereof.

The exemplary control button 503₁ of exemplary audio content website interface page 500 is a FIND STATION button. In one embodiment, upon entry of a search term (e.g., a type of audio content, a genre of music, an artist, and the like) in search bar 502 and selection of control button 503₁, a request is initiated to the server to find stations that are playing and/or likely to be playing content indicated by the search term.

The exemplary control button 503₂ of exemplary audio content website interface page 500 is a HIT ME button. In one embodiment, upon entry of a search term (e.g., a type of audio content, a genre of music, an artist, and the like) in search bar 502 and selection of control button 503₂, a request is initiated to the server to find any search results related to the search term (e.g., radio stations that are playing and/or likely to be playing content indicated by the search term, audio channels on which associated content is or may be available, specific content items available for selection by the user, and the like, as well as various combinations thereof).

Although primarily depicted and described with respect to specific types and numbers of control buttons 503 having specific names, sizes, shapes, functions, and other characteristics associated therewith, it will be appreciated that exemplary audio content website interface page 500 may include different numbers and/or types of buttons having these and/or other names, sizes, shapes, functions, and other characteristics associated therewith.

The three channel bookmark icons 504 of exemplary audio content website interface page 500 provide direct access to the favorite audio content of the user (e.g., radio channels, audio channels, and the like, as well as various combinations thereof).

Although primarily depicted and described herein with respect to a specific layout of audio content website interface page 500, having specific numbers, types, and arrangements of user controls, it will be appreciated that audio content website interface page 500 is merely exemplary, and that various other numbers, types, and arrangements of user controls may be used to implement the audio content website interface page.

In one embodiment, the audio content website enables users to register with the online audio content website, e.g., for free and/or after payment of a fee (e.g., such as where a user may pay for access to a premium version of the online audio content website).

In one embodiment, the registration of a user with the audio content website results in creation of a user profile for the user. The user profile of a user may include any information suitable for use in targeting delivery of audio content to the user. In one embodiment, for example, the user profile information may include any user profile information described herein with respect to other capabilities (e.g., the hybrid radio capability, the context-based radio capability, the real-time traffic condition alerting capability, and the like, as well as various combinations thereof). For example, user profile information may include personal information, user preference information (e.g., a list of favorite radio/audio channels of the user, genres liked and/or disliked by the user, albums/content collections liked and/or disliked by the user, specific albums and/or songs liked and/or disliked by the user, and the like), user context information, and the like, as well as various combinations thereof.

In one embodiment, at least a portion of the user profile information of a user is used by the audio content website to select audio content for delivery to the user.

In one embodiment, at least a portion of the user profile information of a user is provided from the audio content website for presentation to the user (e.g., upon login by the user), thereby enabling the user to select audio content (e.g., by presenting a list of favorite radio/audio channels of the user such that the user may surf between the audio channels for accessing their audio content (e.g., channel bookmark icons 504 of exemplary audio content website interface page 500).

The registration of users and maintaining of associated user profile information for users enables registered users to access the audio content website from any suitable device (e.g., a smartphone of the user, the office computer of the user, and the like) while the users are still provided with targeted delivery of audio content based on the user profile information from the user profiles of the users.

In addition to the audio content website interface page 500, the online radio content website may include any other suitable pages configured for enabling the user to perform functions such as search for audio content, review audio content search results, play audio content, provide real-time feedback on audio content, define and modify user profiles, and the like, as well as various combinations thereof. The design of such pages may be any design(s) suitable for enabling such functions.

In one embodiment, the online radio content website includes one or more user controls configured for enabling users to interact with the online audio content website, including interacting with audio content received from the online radio content website.

The user controls may be any suitable type(s) of user controls. For example, the user controls may be buttons, links, or any other suitable user controls which may be provided via a website.

The user controls may be programmable user controls configured for triggering a programmable action in response to actuation of the user controls.

In one embodiment, for example, a user control(s) may be configured for providing real-time feedback regarding audio content currently playing via the online radio content website.

The user controls may be configured for supporting any suitable type(s) of user feedback regarding audio content currently playing via the online radio content website.

In one embodiment, for example, LIKE and/or DISLIKE buttons are provided on the online radio content website, thereby enabling the user to provide real-time feedback regarding audio content currently playing via the online radio content website (e.g., actuating the LIKE button where the user likes the audio content that is playing and actuating the DISLIKE button where the user dislikes the audio content that is playing).

In one embodiment, for example, the user control(s) configured for supporting user feedback may dynamic. In one embodiment, for example, upon selection of a PLAY button by a user to initiate playing of audio, the PLAY button may then automatically change into a button configured for supporting user feedback (e.g., where the PLAY button is dynamically changed to a LIKE button configured for enabling the user to provide real-time feedback regarding audio playing via the online radio content website). In this embodiment, control over dynamic modification of the user control may be provided locally (e.g., using local logic) or remotely (e.g., by the network).

In such embodiments, the selection of such user controls by the user may cause transmission of an indication of the selection of the user to the online radio content website (e.g., for storing the currently playing song as a favorite song in the user profile of the user, for storing an indication in the user profile of the user that the currently playing song is disliked by the user).

Although primarily depicted and described with respect to use of LIKE and/or DISLIKE buttons, it will be appreciated that user feedback may be provided at any suitable granularity using any suitable user controls.

It will be appreciated that use of such user controls in the manner described ensures consistency of the user experience of the user across all user devices and all conditions (e.g., days, times of day, and the like).

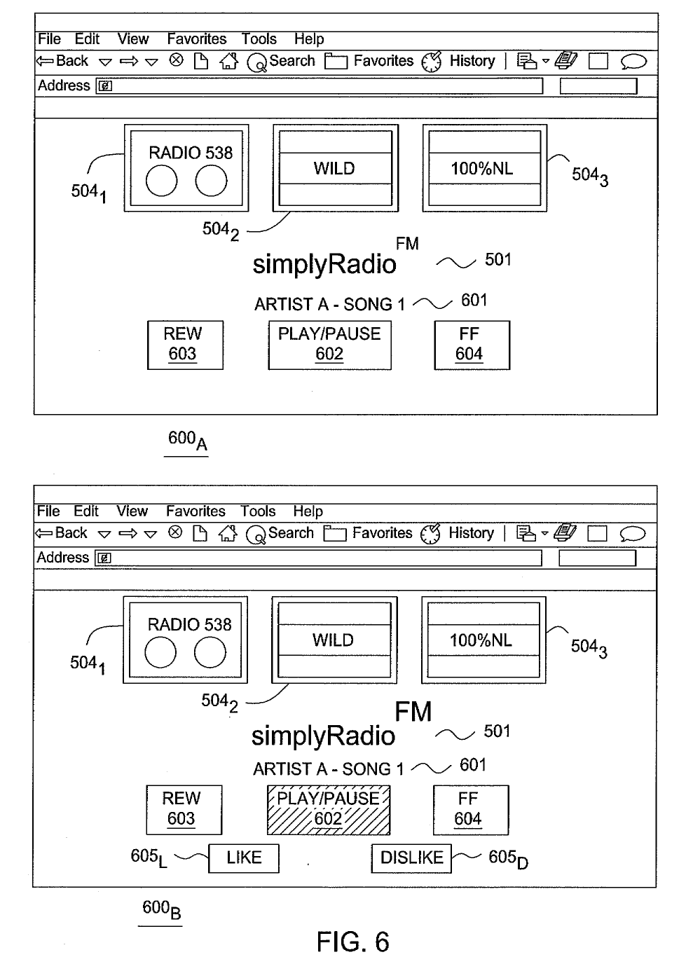

An exemplary design for an audio content website content access page is depicted in FIG. 6. It will be appreciated that this design is merely exemplary, and that any other suitable design may be used.

FIG. 6 depicts an exemplary audio content website content access page for an Internet-based radio capability.

The exemplary audio content website content access page 600 is a page of an associated audio content website hosted on one or more servers in the network.

In one embodiment, exemplary audio content website content access page 600 is displayed in response to selections made on exemplary audio content website interface page 500 (or from any other suitable page of the audio content website).

As depicted in FIG. 6, the exemplary audio content website content access page 600 has two states, denoted as the exemplary audio content website content access page 600_{A} and the exemplary audio content website content access page 600_{B}, for illustrating programmable control of LIKE and DISLIKE buttons for providing user feedback on audio content playing via the audio content website.

As depicted in FIG. 6, the exemplary audio content website content access page 600 includes some elements of the exemplary audio content website interface page 500 (illustratively, website name 501 (simplyRadio^{Fm}) and channel bookmark icons 504).

As depicted in FIG. 6, the exemplary audio content website content access page 600, in both states 600_{A} and 600_{B}, includes an audio content item identifier 601, and a plurality of audio content controls including a PLAY/PAUSE button 602, a REW button 603, and a FF button 604.

The audio content identifier 601 identifies the audio content item being played (e.g., the name of the artist and the name of the song, or any other suitable information which may be associated with music or other types of audio content which may be played via the audio content website).

The audio content controls, namely, PLAY/PAUSE button 602, REW button 603, and FF button 604, enable the user to play/pause the audio content, rewind the audio content, and fast-forward the audio content, respectively.

As described herein, transfer from the first state 600_{A} of audio content website content access page 600 to the second state 600_{B} of audio content website content access page 600 may occur in response to selection of the PLAY/PAUSE button 602 via first state 600_{A} of audio content website content access page 600. As depicted with respect to the second state 600_{B} of audio content website content access page 600, selection of PLAY/PAUSE button 602 via first state 600_{A} of audio content website content access page 600 results in programmatic display of two additional buttons configured for enabling the user to provide real-time feedback on the audio content playing in response to selection of PLAY/PAUSE button 602 via first state 600_{A} of audio content website content access page 600. In one embodiment, as described herein and depicted with respect to second state 600_{B} of audio content website content access page 600, the two additional buttons include a LIKE button 605_{L} and a DISLIKE button 605_{D}. The selection of LIKE button 605_{L} by the user results in transmission of an indication that the user likes the audio content that is currently playing and, similarly, selection of DISLIKE button 605_{D} by the user results in transmission of an indication that the user dislikes the audio content that is currently playing. This like/dislike information is transmitted for use in providing targeted delivery of content, services, and/or recommendations to the user via a targeted communication channel (e.g., such as depicted and described with respect to the hybrid radio capability, the context-based radio capability, the real-time traffic condition alerting capability, the Internet-based radio capability, and the like, as well as various combinations thereof).

Although primarily depicted and described herein with respect to a specific layout of audio content website content access page 600, having specific numbers, types, and arrangements of user controls, it will be appreciated that audio content website content access page 600 is merely exemplary, and that various other numbers, types, and arrangements of user controls may be used to implement the audio content website content access page.

The registration of users and maintaining of associated user profile information for users enables registered users to received targeted content via any suitable device, e.g., a hybrid radio of the user (e.g., within a vehicle of the user, integrated with a home entertainment system of the user, integrated with a clock radio of the user, and the like), an Internet-based radio service (e.g., via a smartphone of the user, a computer of the user, and the like), and the like, as well as various combinations thereof.

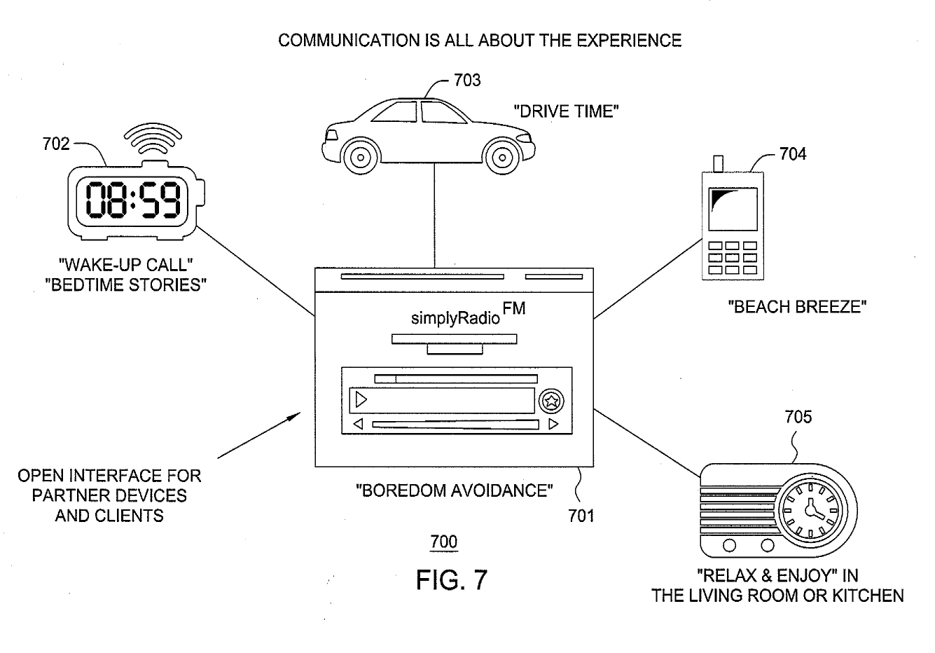

FIG. 7 depicts an exemplary user experience environment illustrating control of the user experience of a user via the Internet-based radio capability.

As depicted in FIG. 7, the user experience environment 700 for the user includes an Internet-based radio capability 701 accessible via a computer of the user, a hybrid radio capability implemented within a clock radio 702 of the user, a hybrid radio capability implemented within a car 703 of the user, an Internet-based radio capability accessible via a smartphone 704 of the user, and a hybrid radio capability implemented within a radio 705 of the user.

As further depicted in FIG. 7, targeted delivery of audio content to the user via such devices may be used to provide an immersive user experience for the user. For example, the user may be provided with any suitable audio content via Internet-based radio capability 701 accessible via the computer of the user, wake-up call music in the morning and bedtime stories at night via the hybrid radio capability implemented within a clock radio 702, audio content desirable to the user while the user is in the car via the hybrid radio capability implemented within the car 703 of the user, audio content desirable to the user while the user is at the beach via the Internet-based radio capability accessible via the smartphone 704 of the user, relaxing background music while the user is relaxing in the living room or kitchen via the hybrid radio capability implemented within the radio 705 of the user. It will be appreciated that this specific combination of device types, capability types, and audio content is merely exemplary and, thus, that any suitable combination of device types, capability types, and audio content may be combined, in accordance with the various embodiments depicted and described herein, to create a user experience.

As will be appreciated by way of reference to FIG. 7 and descriptions of various embodiments provided herein, the user experience described with respect to FIG. 7 may be extended even further. In one embodiment, by maintaining user accounts for users and maintaining all of the user profile information of the users in the network, users may be able to access their accounts from devices other than their own. For example, the user may log into his or her account from a computer of a friend or family member and still receive targeted audio content in the manner depicted and described with respect to various embodiments herein. For example, when traveling, the user may enter some account information in order to access his or her account via the rental car (e.g., for receiving targeted audio content, information about available audio content (e.g., information on local stations playing content that may be of interest to the user), and the like, as well as various combinations thereof).

In this manner, the user is provided with a consistent user experience across all devices, all situations, and all times of day.

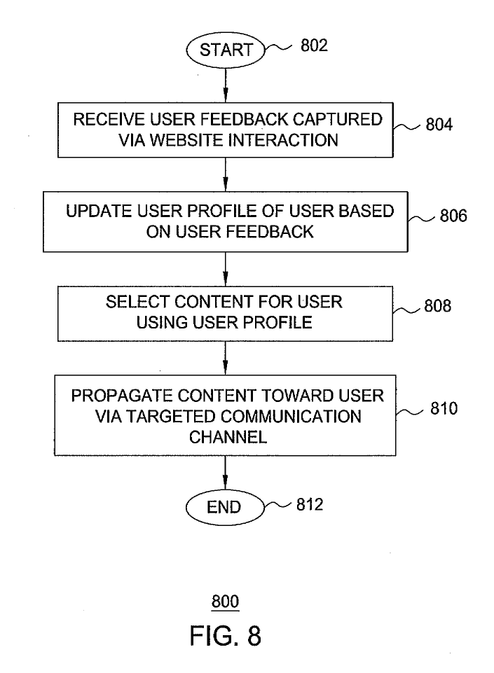

FIG. 8 depicts one embodiment of a method for using an Internet-based radio capability. In one embodiment, method 800 is executed by a server providing the Internet-based radio capability (e.g., by the MS 130 depicted and described with respect to FIG. 1) for providing a consistent user experience to a user.

At step 802, method 800 begins.

At step 804, user feedback is received for the user. The user feedback for the user includes feedback captured via website interaction by the user with the website. This may include any suitable user interaction with the website, and may include any suitable feedback information as described herein with respect to the Internet-based radio capability (as well as any other related capabilities depicted and described herein).

At step 806, a user profile of the user is updated based on the user feedback. The user profile may be updated in any suitable manner. The user profile may include any suitable information.

At step 808, content is selected for the user using the user profile of the user. The selection of content for the user using the user profile of the user may be performed in any suitable manner (e.g., as depicted and described herein with respect to any of the various capabilities, e.g., the hybrid radio capability, the context-based radio capability, the real-time traffic condition alerting capability, and the like).

At step 810, the content selected for the user is propagated toward the user via a targeted communication channel. As depicted and described with respect to the Internet-based radio capability, the content selected for the user may be propagated to any suitable user device or combination of user devices (e.g., to the computer or other device from which the user feedback is received, to one or more hybrid radios of the user, to a smartphone of the user, and the like, as well as various combinations thereof, as will be understood at least by way of reference to FIG. 7).

At step 812, method 800 ends.

Although primarily depicted and described with respect to specific embodiments of the Internet-based radio capability, it will be appreciated that the Internet-based radio capability may be implemented in any other suitable manner in accordance with various embodiments primarily depicted and described herein with respect to other capabilities which may or may not be directly associated with the Internet-based radio capability.

As described herein, the Internet-based radio capability supports audio content in addition to radio-based audio content and, thus, the Internet-based radio capability may be referred to more generally as an Internet-based audio capability.

Although primarily depicted and described hereinabove with respect to various embodiments of audio-based and/or audio-related capabilities, it will be appreciated that the various embodiments of the targeted communication capability depicted and described herein may be applied to other types of content (e.g., image content, video content, multimedia content, and the like) and other associated content delivery platforms (e.g., video broadcast platforms, video-on-demand (VOD) platforms, and the like).

In one embodiment, a video-based targeted communication capability is provided.

The video-based targeted communication capability enables targeted communications to be provided within the content of a video-based system distributing video content, multimedia content, and the like, as well as various combinations thereof.

The video-based targeted communication capability may be provided using any suitable video-based communication system. For example, the video-based targeted communication capability may be provided via one or more of Digital Video Broadcasting (DVB) systems (e.g., DVB-T for terrestrial television systems, DVB-C for cable television systems, DVB-S for satellite television systems, DVB-H or DVB-SH for handhelds-based television systems, and the like), Video-on-Demand (VOD) systems, and the like, as well as various combinations thereof.

In one embodiment, the video-based targeted communication capability is implemented in a manner substantially similar to the targeted communication capabilities depicted and described herein for targeted delivery of audio content and/or other types of content to users (e.g., by modifying various features, elements, functions, and the like of FIGS. 1-8 in a manner for providing targeted delivery of video-based content).

In one embodiment, the video-based targeted communication capability includes a capability for enabling a personalized zapping experience for a broadcast video/multimedia system, an on-demand video/multimedia system, and/or a hybrid broadcast/on-demand video/multimedia system.

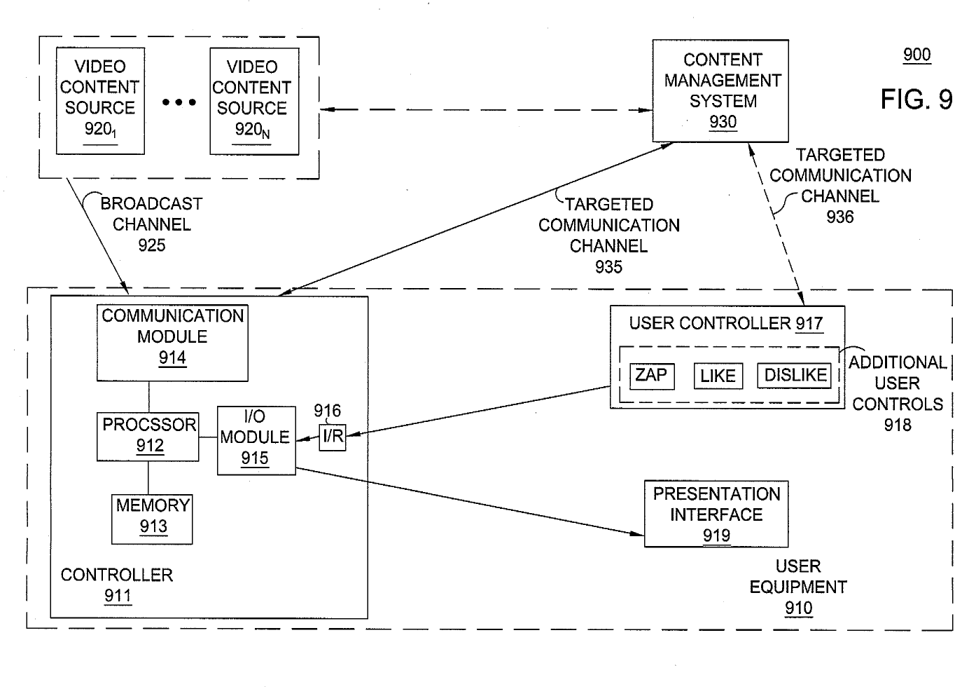

FIG. 9 depicts a high-level block diagram of an exemplary video--based targeted communications system.

As depicted in FIG. 9, the exemplary video-based targeted communications system 900 includes user equipment 910, a plurality of video-based content sources (VCSs) 920₁-920_{N} (collectively, VCSs 920), and a content management system (CMS) 930, and, further, includes a broadcast channel 925 from VCSs 920 to user equipment 910, and a targeted communication channel 935 between CMS 930 and user equipment 910.

In one embodiment, operation of user equipment 910, VCSs 920, and CMS 930 for providing a video-based targeted communication capability for targeted delivery of video content is similar to the operation of HR 110, BASs 120, and MS 130 for providing the hybrid radio capability for targeted delivery of audio content, respectively.

The user equipment 910 may include any suitable devices configured for receiving and displaying video-based content, e.g., a television, a cable box, a modem, a router, various remote controls, and the like, as well as various combinations thereof). For purposes of clarity in describing features of the video-based targeted communication capability, certain devices, and implementation and interaction of such devices, are depicted and described with respect to user equipment 910; however, it will be appreciated that any other suitable types, implementations, and interactions of devices may be used for providing the video-based targeted communication capability.

The user equipment includes controller 911, a user controller 917, and a presentation interface 919.

The controller 911 includes a processor 912, a memory 913, a communication module 914, an input/output (I/O) module 915, and an infrared receiver 916.

The processor 912 is configured for controlling the operation of controller 911. The processor 912 is coupled to each of memory 913, communication module 914, and I/O module 115.

The memory 913 is configured for storing information associated with the operation of controller 911 and user equipment 910, including programs, data, and the like. For example, memory 913 may store programs for controlling the operation of user equipment 910, programs for collecting feedback information to be provided from user equipment 910 to CMS 930 via targeted communication channel 935, video-based content received at user equipment 910 via broadcast channel 925 and/or targeted communication channel 935, targeted communications received at user equipment 910 via targeted communication channel 935, and the like, as well as various combinations thereof.

The communication module 914 is configured to receive broadcast video-based content from VCSs 920 via broadcast channel 925,and to communicate with CMS 930 via targeted communication channel 935 (e.g., to transmit feedback information to CMS 930, received targeted communications from CMS 930, and the like, as well as various combinations thereof). Within the context of receiving broadcast video-based content via broadcast channel 925, the communication module 914 may be configured for being tuned to receive any suitable broadcast video-based content from any suitable broadcast video source. Within the context of targeted communications exchanged via targeted communication channel 925, communication module 914 may be configured for communicating with CMS 930 using any suitable wireline and/or wireless communications technologies. Although depicted and described herein as being a single module, it will be appreciated that communication module 914 may be implemented using any suitable numbers and/or types of communication interfaces.

The I/O module 915 is configured for supporting communication with user controller 917 (via I/R receiver 916) and presentation interface 919. The I/O module 915 is configured for receiving user input from user controller 917 and providing the user input to processor 912 for appropriate handling of the user input (e.g., changing of a television channel, adjustment of volume and other audio controls, entry of feedback information for propagation to CMS 930, and the like, as well as various combinations thereof). The I/O module 915 is configured for receiving information from processor 912 and providing the information to presentation interface 919 (e.g., for displaying video via a display of a television or other suitable display device, playing audio via speakers, for displaying targeted communication information via a display of a television or other suitable display device), and the like, as well as various combinations thereof). Although omitted for purposes of clarity, it will be appreciated that I/O module 915 may interface with any other element(s) of user equipment 910 for providing various functions depicted and described herein.

The user controller 917 may be any user controller suitable for use in controlling various aspects of a video-based targeted communications system. For example, user controller 917 may be a television remote control, a remote control associated with a receiver box, a universal remote control, a smartphone of the user configured for operating as a controller, and the like. The typical design and operation of such controllers will be understood.

In one embodiment, the user controller 917 also may include one or more additional controls not included on typical user controllers, which are associated with various targeted communication capabilities which may be supported. In one such embodiment, for example, the user controller 917 includes three additional user controls 918 as follows: a ZAP button, a LIKE button, and a DISLIKE button. It will be appreciated that such additional user controls may be implemented using any suitable controls, which may depend on the type of user controller on which they are provided (e.g., using one or more buttons, one or more touch screen controls (which may be displayed at all times, accessible via interaction with various menus and options displayed via a touch screen display, and the like), and the like, as well as various combinations thereof). The operation of such additional user controls is described in additional detail below.

The presentation interface 919 may be any suitable presentation interface of and/or associated with a television. The presentation interface 919 includes a display for displaying video and speakers for playing audio associated with the video. For example, presentation interface 919 may be a television, a computer having associated speakers, and the like. The presentation interface 919 may be used to present video-based content(which may or may not include audio and/or other types of content), targeted communication information (e.g., video content, audio content, multimedia content, recommendations for content and services, information associated with content and services, and the like, as well as various combinations thereof), and the like, as well as various combinations thereof. The presentation interface 919 also may be used for presenting any other information associated with the targeted communication capabilities depicted and described herein.

The VCSs 920 may include any broadcast video sources. The user equipment 910 receives broadcast video content from VCSs 920 via the broadcast channel 925).

The CMS 930 is a management system configured for providing various video-based targeted communication capabilities, which may include a capability for enabling a personalized zapping experience.

The CMS 930 supports a targeted communication channel 935 with user equipment 910, thereby enabling interaction between user equipment 910 and CMS 930 for purposes of providing various video-based targeted communication capabilities. The targeted communication channel 935 includes an uplink portion from user equipment 910 to CMS 930 (e.g., enabling feedback to be provided from user equipment 910 to CMS 930) and a downlink portion from CMS 930 to user equipment 910 (e.g., enabling targeted information to be provided from CMS 930 to user equipment 910). As described herein, the targeted information provided to user equipment 910 may include one or more of content (video content, audio content, and the like, as well as various combinations thereof), services, recommendations (e.g., for video content and/or services), and the like, as well as various combinations thereof. As described herein, targeted communication channel 935 may be implemented using any suitable type(s) of bi-directional communications, which may utilize wireless and/or wireline communication capabilities. Although depicted and described herein as being bi-directional, it will be appreciated that in other embodiments, the targeted communication channel 935 may be unidirectional, e.g. implemented as either an uplink or downlink communication channel.

The CMS 930 is configured for receiving feedback information from user equipment 910 via targeted communication channel 935, processing the feedback information for identifying targeted communication information to be provided to user equipment 910, and propagating targeted communication information to user equipment 910. The CMS 930 also may be configured for communicating with various other elements for purposes of providing such functions (e.g., one or more other sources of input information which may be processed for identifying targeted communication information to be provided to user equipment 910, one or more elements configured for providing targeted communication information to user equipment 910 in response to instructions from CMS 930, and the like, as well as various combinations thereof).

Although omitted for purposes of clarity, it will be appreciated that CMS 930 may include a processor, memory, and various other elements configured for providing various video-based targeted communication capabilities. As described herein, the design and operation of CMS 930 may be substantially similar to the design and operation of MS 130 of FIG. 1 (e.g., storing user profiles for users, analysis logic for selecting content for users, content to be provided to users, targeted communication information to be provided to users, and the like as well as various combinations thereof).

The CMS 930 is configured to maintain user profiles for users. The user profile for a user stored user preference information collected for the user. The user profile information maintained in a user profile for a user may be obtained in any suitable manner. In one embodiment, user profile information maintained in a user profile for a user is obtained via user preference information received from the user equipment (e.g., using one or user preference buttons provided on the remote control or other suitable control device used for controlling the user equipment).

The CMS 930 is configured to provide targeted recommendation of content and/or delivery of content to the user equipment of a user based on the user preference information maintained in the user profile of the user. For example, the content management system may select one or more broadcast channels of the broadcast multimedia system (e.g., for providing a recommendation to the user that the user switch to the recommended channel and/or for automatically switching the user to the recommended channel immediately or in response to any suitable trigger condition). For example, the content management system may select one or more on-demand items from the on-demand multimedia system (e.g., for providing a recommendation to the user that the user request the recommended on-demand item and/or for automatically switching the user to the recommended on-demand item immediately or in response to any suitable trigger condition).

As described herein, in one embodiment, the user equipment 910 is hybrid in that it is configured for receiving both broadcast channels and Internet content (e.g., on-demand content and any other content which may be delivered via the Internet and suitable for presentation via a television).

As described herein, in one embodiment, the user controller 917 is a modified version of a typical user controller, including one or more additional user controls (e.g., in addition to the user controls typically provided on remote controls for television systems and other video-based systems) configured for enabling the user to request content and to provide feedback on content currently being presented via the television or other presentation device.

In one embodiment, for example, the one or more additional user controls of user controller 917 include a ZAP button and LIKE and DISLIKE buttons.

In one embodiment, upon selection of the ZAP button, an indication of selection of the ZAP button is communicated to CMS 930, which then provides a content recommendation to the user or provides content to the user, where the associated content is selected based on the user profile of the user. The content may be broadcast content (e.g., a TV channel) or on-demand content. In one embodiment, in which CMS 930 maintains a list of content for the user as part of the user profile of the user, selection of the ZAP button results in selection of the next content item in the list for the user. For example, where the selected content item is a TV channel, CMS 930 may prompt the user with a recommendation to switch to the selected TV channel or automatically switch the user to the selected TV channel (e.g., based on a match between the content playing on the TV channel or about to play on the TV channel and the user profile of the user). Similarly, for example, where the selected content item is an on-demand content item, CMS 930 may prompt the user with a recommendation to switch to the selected on-demand content item or may automatically switch the user to the selected on-demand content item.

In embodiments in which the user is prompted regarding the possibility of switching to another content item, the user may be prompted in any suitable manner. In one such embodiment, for example, the user may be provided with multiple options regarding the recommendation (e.g., switch to the recommended content, skip the recommended content, and the like). For example, an on-demand content item may be presented with the following options which may be selected by the user: “watch now”, “add to favorites and zap” (i.e. I like this content, but do not want to watch it now), “show me something else”, “no, and no other paid content this session” (i.e. only provide TV channels and free content for the rest of this session), and the like.

In such embodiments, following presentation of a selected content item to the user or presentation of a recommendation of a selected content item for the user, if the user is not interested in the presented content item then the user may immediately select the ZAP button again in order to receive the next content item selected for the user or a recommendation regarding the next content item selected for the user.

In one embodiment, upon selection of the LIKE button or DISLIKE button, an indication of whether or not the user likes/dislikes the content (e.g., the video-based content that is currently being presented to the user via the television or other presentation device) is communicated to CMS 930. The indication of the user liking or disliking the content is then stored in the user profile of the user as content preference information. The content preference information may be stored in any suitable manner. In one embodiment, for example, the received indication of the user liking/disliking the content is associated with meta-data of the associated content presented via the user equipment at the time the LIKE or DISLIKE selection is made by the user. In one embodiment, for example, the received indication of the user liking/disliking the content is associated with meta-data of one or more genres of the associated content presented via the user equipment at the time the LIKE or DISLIKE selection is made by the user.

In one embodiment, upon selection of the ZAP button, an indication that the user dislikes the content may be communicated to CMS 930. In one such embodiment, selection of the ZAP button only provides an indication that the user dislikes the content when the user has not watched the associated content for at least a threshold length of time (e.g., quick zapping by the user may be an indication that the user does not like the content that is currently presented and, thus, would like to receive different content).

For example, while watching TV, the user can press the LIKE button during a romantic scene involving Arnold Schwarzenegger in a movie called “Terminator”, and the associated preference information is communicated to CMS 930, thereby increasing the likelihood that CMS 930 will suggest or deliver other romantic movies involving Arnold during zapping.

For example, while watching TV when a commercial is playing, the user can press the DISLIKE or ZAP button and the associated preference information (e.g., the aversion of the user to that type of commercial (e.g., shouting, annoying, repetitive, particular actors, and the like), product, and the like) is communicated to CMS 930.

In such embodiments, the user may press the LIKE and DISLIKE buttons as many times as desired, thereby enabling capturing of user preference information at finer granularity (e.g., on a per-scene basis, per portion of a scene basis, and the like).

Thus, it will be appreciated that user preference information maybe be reported by the user and maintained by CMS 930 at any suitable granularity (e.g., per genre, per content item, per portions of content items, per actor, per subject matter, and the like, as well as various combinations thereof).

Although primarily depicted and described herein with respect to specific numbers, types, and arrangements of such additional user controls on a user controller, it will be appreciated that various other numbers, types, and/or arrangements of such additional user controls may be implemented on the user controller. For example, one or more such additional user controls may be implemented using other types of controls (e.g., using touch screen capabilities, using menus and buttons, using voice-activated controls, and the like).

Although primarily depicted and described herein with respect to embodiments in which such additional user controls are implemented on a remote control, in other embodiments one or more such additional user controls may be implemented on one or more other user devices suitable for use in providing such capabilities (e.g., on a remote control device that is separate from existing remote control devices, on the television, on a smartphone of the user, and the like, as well as various combinations thereof).

In one such embodiment, in which the user controller is implemented using a device supporting Internet access (e.g., a smartphone of the user), a separate targeted communication channel 936 may be implemented between the user controller 910 and CMS 930 (i.e., not via user equipment 910). The separate targeted communication channel 936 may be in place of or in addition to the targeted communication channel 935.

Although primarily depicted and described with respect to use of the personalized zapping experience capability by a single user, it will be appreciated that the personalized zapping experience capability may be provided in multi-user environments (e.g., multi-user houses, businesses, and the like). In such embodiments, the multiple users accessing the user equipment 910 may be distinguished in any suitable manner. In one embodiment, for example, at least a portion of the users may be provided with their own user controller devices, such that interaction by the various users with content may be recorded and propagated to CMS 930 on a per-user basis (e.g., each user has his or her own user controller, subsets of users share user controllers, and the like). In one such embodiment, for example, one or more of the users may use his or her smartphone to interact with the content, such that interaction by the various users with content may be recorded and propagated to CMS 930 on a per-user basis. The multiple users accessing the user equipment, and interacting with the content, may be distinguished in any suitable manner.

The personalized zapping experience capability provides significant improvement over existing video-based content delivery systems. For example, existing television systems allow users to select TV channels by channel number, and to surf using PREV and NEXT buttons for zapping to the previous/next TV channels relative to the currently selected TV channel; however, this is highly inefficient, especially for the signaling and buffering required in IPTV systems). For example, companies such as Netflix have developed recommendation algorithms that take per-movie user ratings into account and suggest other movies based on viewing history and ratings; however such algorithms do not support the more fine-grained profiling enabled by the personalized zapping experience capability (e.g., on a per-scene basis, a per-scene-type basis, per actor basis, and the like). For example, Google is now moving into television and offers searches across television channels via Electronic Programming Guides (EPGs) and Internet content (e.g., YouTube); however, this does not provide the traditional zapping experience associated with television, much less the capabilities of the personalized zapping experience capability depicted and described herein. The personalized zapping experience capability provides users with a more efficient way to discover channels and content to watch, using the traditional zapping experience associated with television, thereby enabling content producers and content providers to better understand the likes and dislikes of users, enabling content providers to up-sell on-demand content with a high likelihood of conversion (via mixing with the traditional zapping experience), and may provide various other benefits.

Although the video-based targeted communication capability is primarily depicted and described within the context of providing television content, it will be appreciated that the video-based targeted communication capability may provide other types of video-based content (e.g., video-on-demand and the like).

Although primarily depicted and described herein with respect to embodiments in which the video-based targeted communication capability is provided within a video-based content delivery system, in one embodiment the principles of the Internet-based audio capability depicted and described herein may be applied for providing an Internet-based video capability. In this embodiment, the Internet-based video capability may be implemented in a manner similar to implementation of the Internet-based audio capability. For example, the Internet-based video capability (1) is adapted for combining the traditional television experience with features of the Internet in a simple and user-friendly manner, thereby reinvigorating television, which has been losing audience share to other sources of video content), (2) enables blending of video contents with user information (e.g., user habits, user preferences, and the like, as well as various combinations thereof), (3) enables initiation of interaction with consumers and communication with consumers in a personalized, interactive, targeted manner, thereby creating an optimum user experience, at the right place and time, to enable various brands to engage with existing and potential customers and establish and maintain a lasting relationship, and (4) provides a uniform, elegant, simple, unobtrusive user experience that is consistent across all user devices and situations in which the users utilize video content, thereby creating ideal channels for enabling various brands to communicate their messages and build their images. As with the Internet-based audio capability, the Internet-based video capability may be supported by and/or accessed from any suitable computing device (e.g., a desktop computer, a laptop computer, a notebook, a subnotebook, a smartphone, a cellular phone, or any other suitable device on which video-based content may be presented).

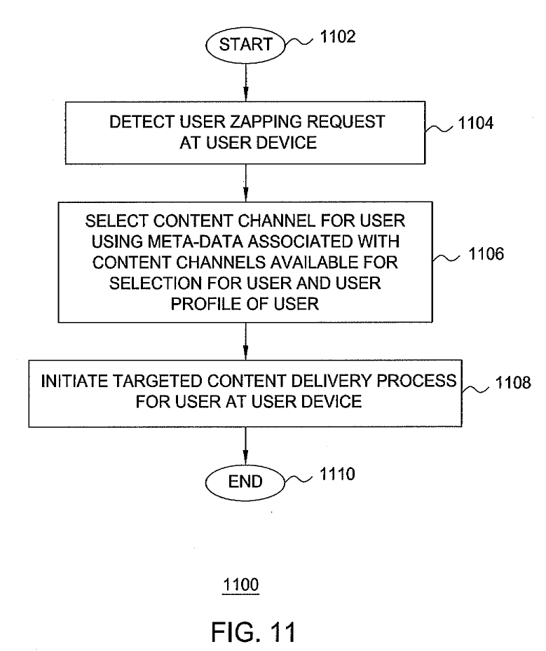

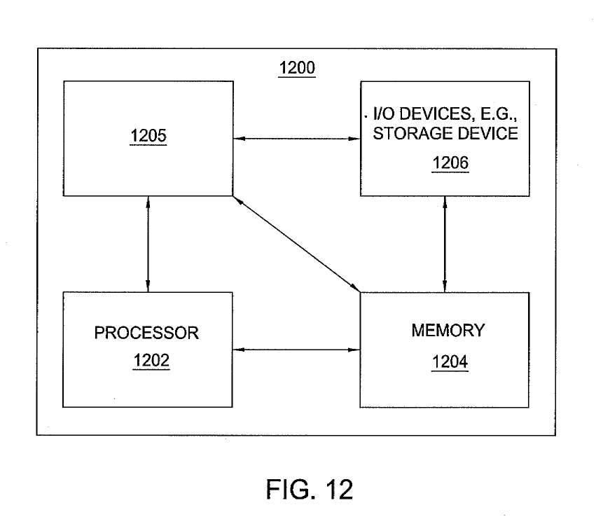

As described herein with respect to embodiments of the hybrid radio, various principles of the personalized zapping experience capability for use with video-based systems also may be applied for use with the various hybrid radio embodiments depicted and described herein (e.g., using LIKE, DISLIKE, and/or ZAP buttons available on a radio; maintaining similar user profiles including user preference information for audio-based content; and the like, as well as various combinations thereof). Embodiments for providing a personalized zapping experience in hybrid radio systems and video-based systems are depicted and described with respect to FIG. 11 (which depicts and describes personalized zapping provided via a targeted communication channel) and FIG. 12 (which depicts and describes personalized zapping provided via local processing).

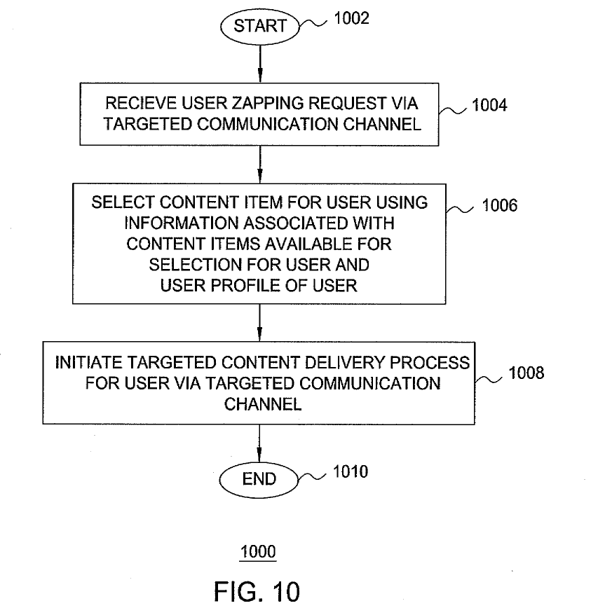

FIG. 10 depicts one embodiment of a method for providing a personalized zapping experience using a targeted communication channel. The method 1000 may be used for providing a personalized zapping experience within the context of a hybrid radio system, a video-based system, or any other suitable system in which such a personalized zapping experience may be provided. The method 1000 of FIG. 10 may be performed by a content management system or any other suitable device.

At step 1002, method 1000 begins.

At step 1004, a user zapping request is received via the targeted communication channel.

At step 1006, a content item is selected for the user using information associated with content items available for selection for the user and a user profile of the user.

The content item may be any suitable content item available for selection for the user (e.g., audio content, video content, multimedia content, and the like).

The information associated with content items available for selection for the user may include any information suitable for use in describing the content items in a manner enabling selection of the content item based on the user profile of the user (e.g., the name of the content item, the name(s) of one or more artists associated with the content item, one or more characteristics of the content item, and the like, as well as various combinations thereof). The information associated with content items available for selection for the user may be obtained by the user device in any suitable manner, e.g., from any suitable source (e.g., from an EPG of available radio stations in a hybrid radio system, from an EPG of available television channels in a television system, and the like), at any suitable time (e.g., prior to execution of method 1000, during execution on method 1000, and the like), and the like, as well as various combinations thereof.

The user profile may include any suitable information, such as personal information of the user, user preference information of the user (which may include real-time feedback information), user context information, and the like. The user profile of the user may be created and updated in any suitable manner.

The process for selecting a content item for the user using a user profile of the user of the user device may be performed using any suitable matching/selection algorithm(s).

At step 1008, a targeted content delivery process is initiated for the user via the targeted communication channel. The targeted content delivery process is based on the content item selected for the user. The targeted content delivery process may include sending a content recommendation to the user recommending that the user access the selected content item (e.g., by switching to a particular television channel, setting a recorder to record the program to be provided via a particular television channel, requesting to receive the content item via an on-demand service, and the like), sending the selected content item to the user (e.g., where the content item is an on-demand content item), initiating a control message(s) for automatically switching the user to a particular television channel on which the selected content item is playing, and the like, as well as various combinations thereof.

At step 1010, method 1000 ends.

FIG. 11 depicts one embodiment of a method for providing a personalized zapping experience using local processing. The method 1000 may be used for providing a personalized zapping experience within the context of a hybrid radio system, a video-based system, or any other suitable system in which such a personalized zapping experience may be provided. The method 1100 of FIG. 11 may be performed by any suitable user device (e.g., a hybrid radio in a hybrid radio system, user equipment in a video-based system, or any other suitable device).

At step 1102, method 1100 begins.

At step 1104, a user zapping request is detected at the user device.

At step 1106, a content channel is selected for the user using meta-data associated with content channels available to the user device and a user profile of the user of the user device.

The content channel may be any suitable content channel available for selection at the user device (e.g., a broadcast radio station in a hybrid radio system, a television channel in a television system, and the like).

The meta-data may include any suitable meta-data which may be associated with the available content channels. For example, in a hybrid radio system in which the content channels are radio stations, the meta-data may include information such as the name of the song or other audio content currently playing on the radio station, the name of the artist/speaker of the song or other audio content currently playing on the radio station, one or more characteristics of the audio content currently playing on the radio station (e.g., genre, rating, and the like), and the like, as well as various combinations thereof). For example, in a television system in which the content channels are television channels, the meta-data may include information such as the name of the television programming currently available on the television channel, the actor(s)/actress(es) of the television programming, one or more characteristics of the television programming currently available on the television channel (e.g., genre, rating, and the like), and the like, as well as various combinations thereof).

The meta-data may be obtained by the user device in any suitable manner, e.g., from any suitable source (e.g., from an EPG of available radio stations in a hybrid radio system, from an EPG of available television channels in a television system, and the like), at any suitable time (e.g., prior to execution of method 1100, during execution on method 1100, and the like), and the like, as well as various combinations thereof. In such embodiments, the meta-data may be obtained by the user device periodically and stored on the user device for use in providing the personalized zapping experience.

The user profile may include any suitable information, such as personal information of the user, user preference information of the user (which may include real-time feedback information), user context information, and the like. The user profile of the user may be created and updated in any suitable manner. In such embodiments, the user profile may be stored on the user device for use in providing the personalized zapping experience.

The process for selecting a content channel for the user using meta-data associated with content channels available to the user device and a user profile of the user of the user device may be performed using any suitable matching/selection algorithm(s).

At step 1008, a targeted content delivery process is initiated for the user at the user device. The targeted content delivery process is based on the content channel selected for the user. The targeted content delivery process may include providing a recommendation to the user recommending that the user switch to the selected content channel (e.g., via an aural and/or visual indicator provided to the user via the user device, or using any other suitable mechanism for providing such a recommendation), by automatically switching to the selected content channel (e.g., adjusting the radio tuner to the selected radio station in a hybrid radio system, adjusting the television tuner to the selected television channel in a television system, and the like), and the like, as well as various combinations thereof.

At step 1110, method 1000 ends.

Although omitted for purposes of clarity, one or more of the management system depicted and described herein may provide functions for one or more providers (e.g., content providers, service providers, and the like, as well as providers operating in multiple such roles). In such embodiments, user preference information of users may be used across different services of single providers, across different providers of the same type (e.g., across different audio providers, across different video providers, and the like), across different provider types (e.g., by audio and video content providers), and the like, as well as various combinations thereof.

Although primarily depicted and described herein within the content of a single user being associated with a targeted communication account, it will be appreciated that in many cases there may be multiple users associated with a single targeted communication account. This may arise, for example, in the case of a family sharing an account, roommates sharing an account, or any other similar situation. In one embodiment, users may be provided with a capability for indicating, to the management system, the user or set of users currently using the targeted communication capability, such that delivery of content, services, and the like, may be tailored accordingly. This enables preferences of multiple users to be considered when selecting content, services, recommendations, and/or other information to be provided to the users (e.g., making selections based on overlapping preferences of the users, making selections for each of the users and alternating delivery of the selections such that each user is satisfied, and the like, as well as various combinations thereof. For example, when a husband and wife are in the car that includes a hybrid radio, only audio content that preferred by both is delivered via the hybrid radio. For example, when a husband and wife are watching television with their children, the video-based content selected for the family may be tailored accordingly (e.g., on G-rated programs and movies, programs and movies from genres preferred by each member of the family, and the like, as well as various combinations thereof).

Although primarily depicted and described with respect to use of an IP-based targeted communication channel, the targeted communication channel may utilize any other suitable communication protocol(s) (e.g., in addition to or in place of IP).

FIG. 12 depicts a high-level block diagram of a computer suitable for use in performing functions described herein.

As depicted in FIG. 12, computer 1200 includes a processor element 1202 (e.g., a central processing unit (CPU) and/or other suitable processor(s)), a memory 1204 (e.g., random access memory (RAM), read only memory (ROM), and the like), a cooperating module/process 1205, and various input/output devices 1206 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 1205 can be loaded into memory 1204 and executed by processor 1202 to implement the functions as discussed herein. Thus, cooperating process 1205 (including associated data structures) can be stored on a computer readable storage medium, e.g., RAM memory, magnetic or optical drive or diskette, and the like.

It will be appreciated that computer 1200 depicted in FIG. 12 provides a general architecture and functionality suitable for implementing functional elements described herein and/or portions of functional elements described herein. For example, the computer 1200 provides a general architecture and functionality suitable for implementing one or more of HR 110, BASs 120, MS 130, user equipment 910, VCSs 920, CMS 930, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a first communication module configured for receiving broadcast content via a broadcast channel; and
a second communication module configured for supporting a data communication channel, wherein the second communication module is configured for at least one of transmitting feedback information via the data communication channel and receiving targeted communication information via the data communication channel.

2. The apparatus of claim 1, wherein the broadcast content comprises at least one of audio content, video content, and multimedia content.

3. The apparatus of claim 1, wherein the broadcast content comprises audio content and the broadcast channel comprise a broadcast audio channel.

4. The apparatus of claim 3, wherein the broadcast audio channel comprises one of a Frequency Modulation (FM) radio channel, an Amplitude Modulation (AM) radio channel, and a satellite radio channel.

5. The apparatus of claim 3, wherein the first and second communication modules are disposed within a radio device.

6. The apparatus of claim 1, wherein the feedback information comprises at least one of:
user preference information indicative of whether a user likes or dislikes the broadcast content received via the broadcast channel;
user context information associated with a user, wherein the user context information comprises at least one of a location of the user, at least one characteristic of a location of the user, a time of day at the location of the user, and a mood of the user; and
traffic condition reporting information indicative of a traffic condition.

7. The apparatus of claim 1, wherein the targeted communication information comprises at least one of:
content selected for a user based on a user profile of the user;
a recommendation of content for a user, wherein the recommendation is made for the user based on a user profile of the user; and
a traffic alert adapted for alerting a user to a traffic condition expected to be experienced by the user.

8. The apparatus of claim 7, wherein, when the targeted communication information comprises the traffic alert, the targeted communication information further comprises at least one recommendation for the user, wherein the recommendation is selected for the user based at least in part on a length of time that the user is expected to be impacted by the traffic condition of the traffic alert.

9. An apparatus, comprising:
a processor configured for:
controlling presentation of broadcast content received via a broadcast channel; and
controlling communication via a data communication channel, wherein communication via the data communication channel comprises at least one of transmitting feedback information via the data communication channel and receiving targeted communication information via the data communication channel.

10. The apparatus of claim 9, wherein the broadcast content comprises at least one of audio content, video content, and multimedia content.

11. The apparatus of claim 9, wherein the broadcast content comprises audio content and the broadcast channel comprise a broadcast audio channel.

12. The apparatus of claim 11, wherein the broadcast audio channel comprises one of a Frequency Modulation (FM) radio channel, an Amplitude Modulation (AM) radio channel, and a satellite radio channel.

13. The apparatus of claim 11, wherein the processor is disposed within a radio device, wherein radio device comprises one of a radio disposed within a vehicle, a standalone radio device, and a radio integrated with a home entertainment system.

14. The apparatus of claim 9, wherein the processor is disposed within a computing device, wherein computing device is one of a desktop computer, a laptop computer, a subnotebook, a tablet, a smartphone, and a cellular phone.

15. The apparatus of claim 9, wherein the feedback information comprises at least one of:
user preference information indicative of whether a user likes or dislikes the broadcast content received via the broadcast channel;
user context information associated with a user, wherein the user context information comprises at least one of the location of the user, at least one characteristic of the location of the user, a time of day at the location of the user, and a mood of the user; and
traffic condition reporting information indicative of a traffic condition.

16. The apparatus of claim 9, wherein the targeted communication information comprises at least one of:
content selected for a user based on a user profile of the user;
a recommendation of content for a user, wherein the recommendation is made for the user based on a user profile of the user; and
a traffic alert adapted for alerting a user to a traffic condition expected to be experienced by the user.

17. The apparatus of claim 16, wherein, when the targeted communication information comprises the traffic alert, the targeted communication information further comprises at least one recommendation for the user, wherein the recommendation is selected for the user based on a length of time the user is expected to be impacted by the traffic condition of the traffic alert

18. A method for interacting with a radio, comprising:
receiving feedback information from the radio via a bidirectional channel with the radio, wherein the radio is adapted for receiving broadcast audio content via a broadcast audio channel; and
propagating targeted communication information toward the radio via the bidirectional channel with the radio.

19. The method of claim 18, wherein the feedback information is associated with broadcast audio content received at the radio via the broadcast audio channel.

20. The method of claim 19, wherein the feedback information comprises user preference information indicative of whether a user of the radio likes or dislikes the broadcast audio content received at the radio via the broadcast audio channel.

21. The method of claim 19, wherein the targeted communication information comprises at least one of audio content and a recommendation of audio content for the user.

22. The method of claim 18, wherein the feedback information comprises user context information.

23. The method of claim 22, wherein the user context information comprises at least one of a location of the user, at least one characteristic of a location of the user, and a mood of the user.

24. The method of claim 22, wherein the targeted communication information comprises at least one of audio content and a recommendation of audio content for the user.

25. The method of claim 18, wherein the feedback information comprises an indication of a traffic condition.

26. The method of claim 18, wherein the targeted communication information comprises a traffic alert adapted for alerting the user to a traffic condition expected to be experienced by the user.

27. The method of claim 26, wherein the targeted communication information further comprises at least one recommendation for the user, wherein the recommendation is selected for the user based at least in part on a length of time the user is expected to be impacted by the traffic condition of the traffic alert.

28. The method of claim 18, wherein the bidirectional channel is supported by a network, wherein the targeted communication information comprises content, using a recommendation algorithm configured for recommending more broadcast content than unicast content during a traffic load condition of the network.
